(19) United States
(12) Patent Application Publication
(10) Pub. No.: US 2026/0350837 A1
(43) Pub. Date: Nov. 5, 2026

(54) COOPERATIVE RF-ASSISTED CAMERA CALIBRATION FOR VISUAL POSITIONING

(71) Applicant: QUALCOMM Incorporated, San Diego, CA (US)

(72) Inventors: Marko ANGJELICHINOSKI, San Diego, CA (US); Alexandros MANOLAKOS, Athens (GR); Khurram Usman MAZHER, San Diego, CA (US); Varun Amar REDDY, San Diego, CA (US); Krishna Kiran MUKKAVILLI, San Diego, CA (US)

(21) Appl. No.: 19/476,884

(22) PCT Filed: Apr. 9, 2024
(86) PCT No.: PCT/US2024/023752

§ 371 Date: Oct. 20, 2025

(30) Foreign Application Priority Data
May 26, 2023 (GR) 20230100423

(51) Int. Cl. G06T 7/80; G06V 20/10; H04N 7/18; H04W 64/00

(52) U.S. Cl. CPC G06T 7/80; G06V 20/176; H04N 7/183; H04W 64/006; G06T 2207/20081; G06T 2207/30232

(57) ABSTRACT

Aspects presented herein may enable a device to use RF-based features for camera calibration. A first network node receives, from a network entity, an indication of a set of training points and at least one image for an area captured by at least one camera of at least one second network node, where the first network node is in a field-of-view (FOV) of the at least one camera of the at least one second network node, where the indication includes, for each of the set of training points, a pixel location in the at least one image and a world location. The first network node estimates a projective transformation between a world location of an object and a pixel location of the object in the at least one image, based on the set of training points and a known location or an estimated location of the first network node.

### CROSS-REFERENCE TO RELATED APPLICATION

This application claims the benefit of Greece Patent Application Serial No. 20230100423, entitled “COOPERATIVE RF-ASSISTED CAMERA CALIBRATION FOR VISUAL POSITIONING” and filed on May 26, 2023, which is expressly incorporated by reference herein in its entirety.

### TECHNICAL FIELD

The present disclosure relates generally to communication systems, and more particularly, to a wireless communication involving visual positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives, from a network entity, an indication of a set of training points and at least one image for an area captured by at least one camera of at least one second network node, where the first network node is in a field-of-view (FOV) of the at least one camera of the at least one second network node, where the indication includes, for each of the set of training points, a pixel location in the at least one image and a world location. The apparatus estimates a projective transformation between a world location of an object and a pixel location of the object in the at least one image, based on the set of training points and a known location or an estimated location of the first network node.

In an aspect of the disclosure, a method, a computer-readable medium, and an apparatus are provided. The apparatus selects, for a first network node including a known location or an estimated location, at least one second network node, where the first network node is in a field-of-view (FOV) of the at least one second network node. The apparatus transmits, for the at least one second network node, a request to capture at least one image for an area using at least one camera, where the at least one image includes the first network node. The apparatus receives, from the at least one second network node, the at least one image for the area based on the request.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of visual-based positioning in accordance with various aspects of the present disclosure.

FIG. 6 is a diagram illustrating an example scenario of a camera performing camera calibration using radio frequency (RF)-based features in accordance with various aspects of the present disclosure.

FIG. 7 is a diagram illustrating an example projective transformation in accordance with various aspects of the present disclosure.

FIG. 8 is a diagram illustrating an example of a fusion engine architecture associated with visual positioning in accordance with various aspects of the present disclosure.

FIG. 9 is a communication flow illustrating an example procedure of a cooperative network device with RF capability (CpRFDev) initiating UE-assisted visual positioning in accordance with various aspects of the present disclosure.

FIG. 10 is a communication flow illustrating an example procedure of a CpRFDev initiating UE-based visual positioning in accordance with various aspects of the present disclosure.

FIG. 11 is a communication flow illustrating an example procedure of a network device with camera and RF capability (CamDev) initiating UE-assisted visual positioning in accordance with various aspects of the present disclosure.

FIG. 12 is a communication flow illustrating an example procedure of a CamDev initiating UE-based visual positioning in accordance with various aspects of the present disclosure.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a flowchart of a method of wireless communication.

FIG. 17 is a flowchart of a method of wireless communication.

FIG. 18 is a diagram illustrating an example of a hardware implementation for an example network entity.

### DETAILED DESCRIPTION

Aspects presented herein may improve the accuracy and reliability of visual-based positioning, where a device (e.g., a UE, a network node, etc.) may be configured to use radio frequency (RF)-based features for camera calibration (for performing visual positioning). For example, in network scenarios, RF-based location estimates of various network devices (e.g., UEs, access points (APs), base stations/transmission-reception points (TRPs), etc.) in the FOV of a camera may be used as scene features for the camera calibration. Aspects presented herein may also improve RF-based location estimates of connected devices in the FOV of a camera, and may enable a camera (or a device associated with the camera) to reliably estimate the location of other devices, objects, and/or points of interests. Aspects presented herein may rely entirely on network assets for scene representation (e.g., network devices, RF positioning engine, algorithms, servers, etc.), which may provide an advantage over other camera calibration methods in terms of privacy.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

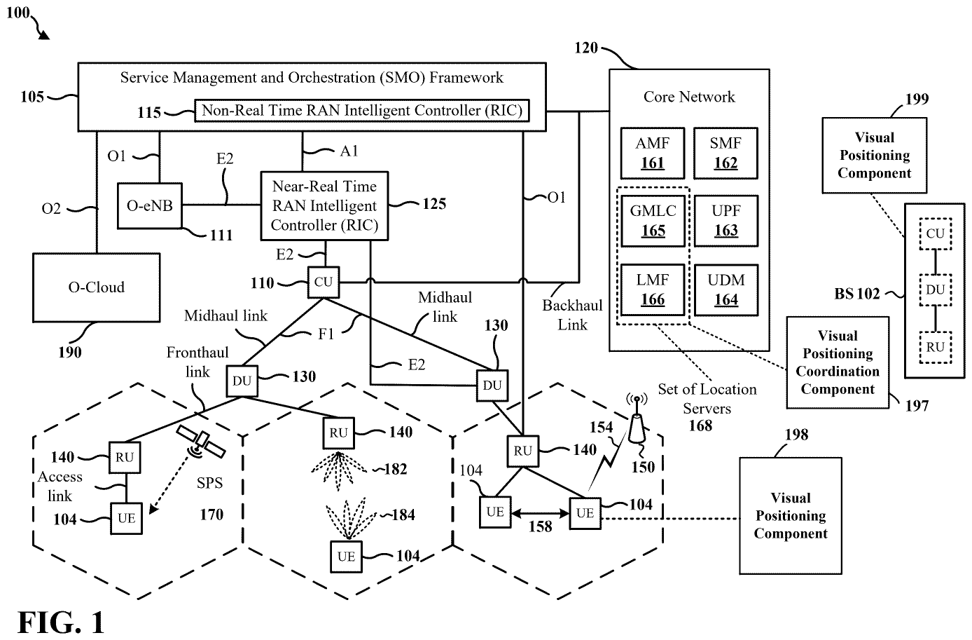

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth®, Wi-Fi® based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth® signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a visual positioning component 198 (and/or the base station 102 may include a visual positioning component 199) that may be configured to receive, from a network entity, an indication of a set of training points and at least one image for an area captured by at least one camera of at least one second network node, where the first network node is in a field-of-view (FOV) of the at least one camera of the at least one second network node, where the indication includes, for each of the set of training points, a pixel location in the at least one image and a world location; and estimate a projective transformation between a world location of an object and a pixel location of the object in the at least one image, based on the set of training points and a known location or an estimated location of the first network node.

In certain aspects, the one or more location servers 168 may include a visual positioning coordination component 197 that may be configured to select, for a first network node including a known location or an estimated location, at least one second network node, where the first network node is in a FOV of the at least one second network node; transmit, for the at least one second network node, a request to capture at least one image for an area using at least one camera, where the at least one image includes the first network node; and receive, from the at least one second network node, the at least one image for the area based on the request.

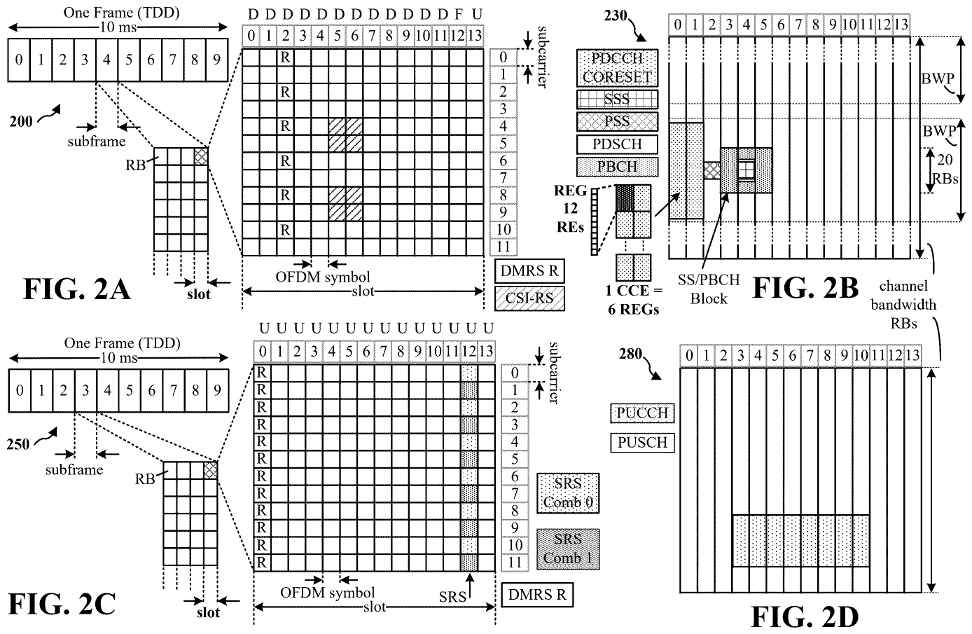

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 24*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

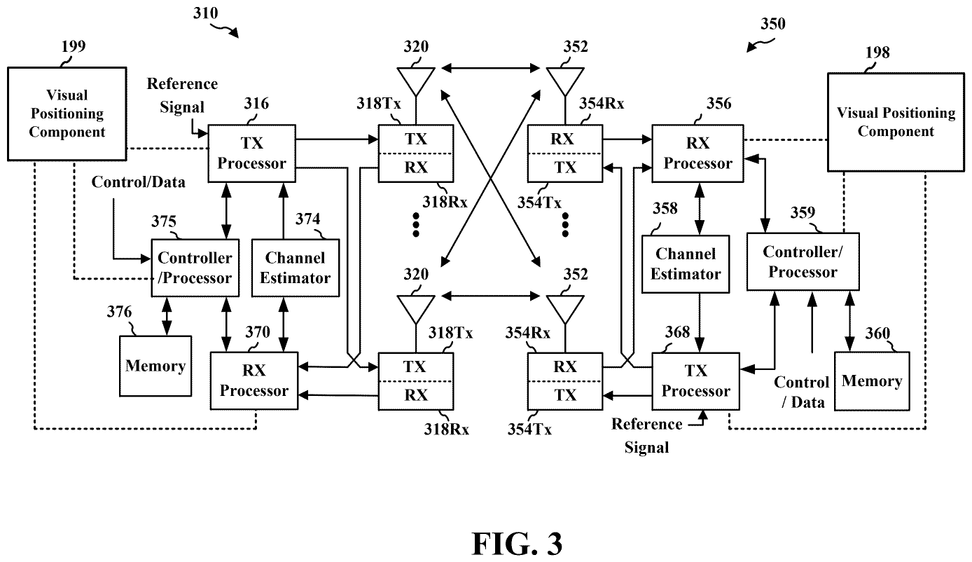

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency-domain, and then combined together using an Inverse Fast Fourier Transform (IFFT) to produce a physical channel carrying a time-domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency-domain using a Fast Fourier Transform (FFT). The frequency-domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the visual positioning component 198 of FIG. 1.

At least one of the TX processor 316, the RX processor 370, and the controller/processor 375 may be configured to perform aspects in connection with the visual positioning component 199 of FIG. 1.

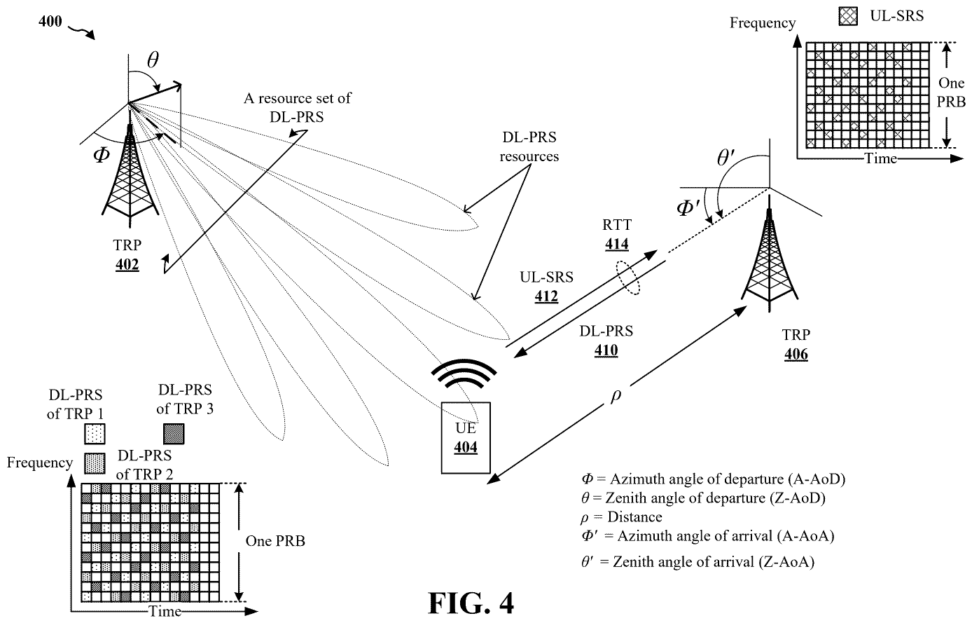

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}|. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, tracking reference signals (TRS), PTRS, cell specific reference signal (CRS), CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

In addition to Global Navigation Satellite Systems (GNSS)-based positioning and network-based positioning (e.g., as described in connection with FIG. 4), various visual-based positioning has also been developed to provide alternative/additional positioning mechanisms/modes. Visual-based positioning, which may also be referred to as “visual positioning,” “vision-based positioning,” “camera-based positioning,” and/or “camera-based visual positioning,” is a positioning mechanism/mode that uses images captured by at least one camera to determine the location of a target (e.g., a UE, one or more objects that are in the field-of-view (FOV) of the at least one camera, etc.). For example, images captured by a camera in a warehouse may be used for calculating/estimating the location of inventories in the warehouse.

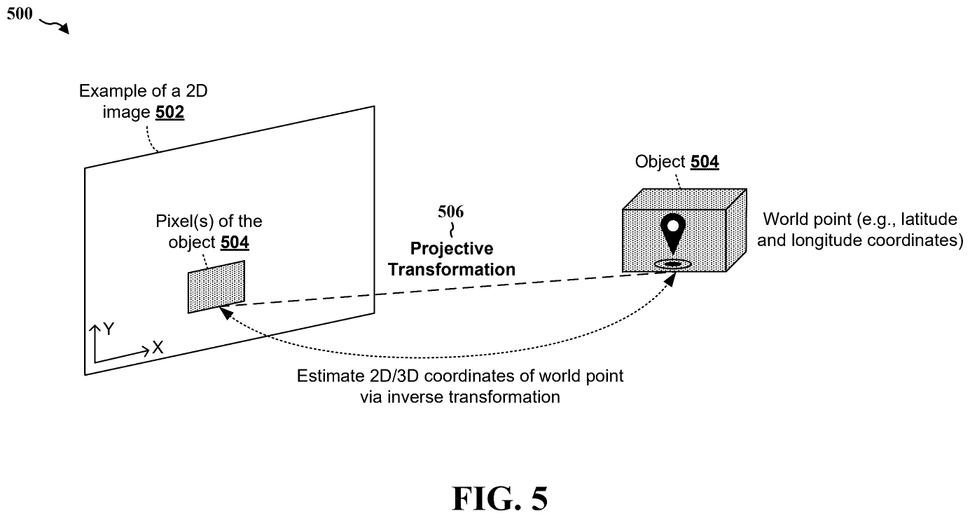

FIG. 5 is a diagram 500 illustrating an example of visual-based positioning in accordance with various aspects of the present disclosure. Visual-based positioning may offer high-accuracy position estimation, where coordinates (e.g., two-dimensional (2D)/three-dimensional (3D) coordinates, latitude and longitude coordinates, etc.) of points of interests (e.g., positions of UEs, objects in a warehouse, etc.) may be computed from the corresponding pixels of a 2D image using (the inverse of) a projective transformation that maps world points onto the 2D image. For example, as shown at 506, projective transformation may enable coordinates of an object 504 to be computed from the corresponding pixel of the object 504 on a 2D image 502, where the projective transformation may map the world points of the object 504 onto the 2D image 502. In some scenarios, the (accuracy and reliability of) projective transformation may depend on the camera pose (e.g., the position and the orientation of a camera) and a set of internal camera parameters (e.g., focal length, resolution, image size, etc.). Thus, knowing the (inverse of) projective transformation may be a key for reliable/accurate localization of points/objects of interest in the FOV of a camera.

In one example, the projective transformation may be learned by a device (e.g., a UE, a TRP, a network node, etc.) based on a process called camera calibration. During camera calibration, training data may be provided to the device which matches pairs of 2D world point/3D world point of one or more objects with known coordinates and the pixel locations of their corresponding image projections. For example, scene features may be extracted from an image, followed by matching with features obtained from scene representation (e.g., such as 3D model). In some scenarios, the camera calibration process may not be reliable if the extracted features are not descriptive (e.g., in an indoor environment, under low lighting, at nighttime, etc.) or the scene representation is absent (e.g., the 3D model is not available for location or access to external server for 3D model retrieval is not possible, etc.). Also, in some use-cases, the projective transform may change frequently due to mobility or sporadic internal camera adjustments (examples include mobile smartphones, virtual reality (VR) glasses, unmanned aerial vehicles (UAVs), self-driving cars etc.).

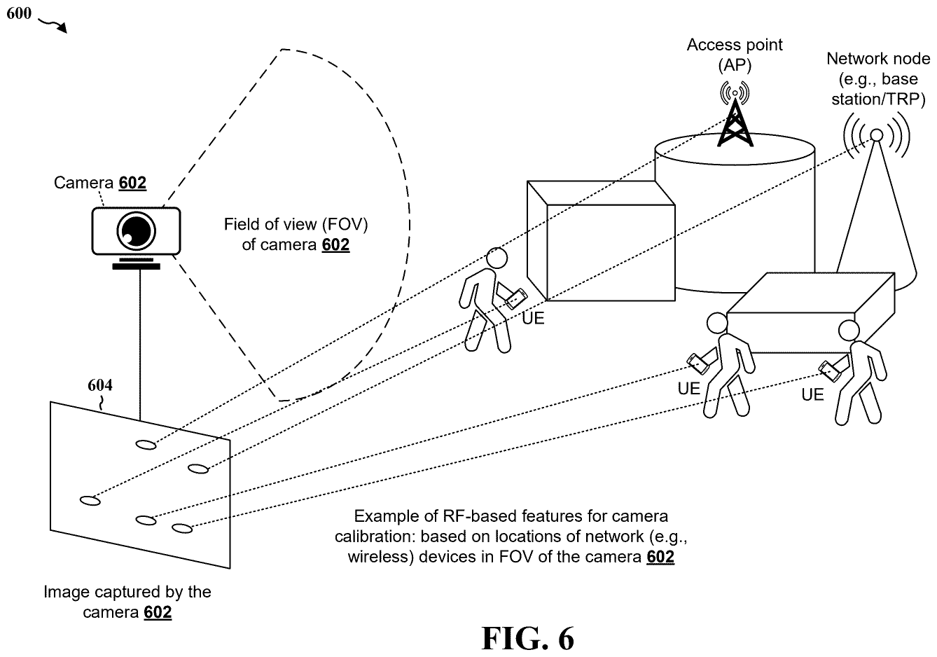

Aspects presented herein may improve the accuracy and reliability of visual-based positioning, where a device (e.g., a UE, a network node, etc.) may be configured to use radio frequency (RF)-based features for camera calibration. For example, FIG. 6 is a diagram 600 illustrating an example scenario of a camera performing camera calibration using RF-based features in accordance with various aspects of the present disclosure. As shown at 604, in network scenarios, RF-based location estimates of various network devices (e.g., UEs, access points (APs), base stations/TRPs, etc.) in the FOV of a camera 602 may be used as scene features for the camera calibration. Aspects presented herein may also improve RF-based location estimates of connected devices in the FOV of a camera, and may enable a camera (or a device associated with the camera) to reliably estimate the location of other devices, objects, and/or points of interests. Aspects presented herein may rely entirely on network assets for scene representation (e.g., network devices, an RF positioning engine, algorithms, servers, etc.), which may provide an advantage over other camera calibration methods in terms of privacy.

For purposes of the present disclosure, an RF device may refer to any device with the capability of transmitting RF signals, such that the device may be used for positioning. An RF-based location estimate may refer to an estimation of an RF device's location using at least one RF-related technology, such as Bluetooth®, Wi-Fi®, RF sensing, and/or ultrawide band (UWB), etc. A location estimate may also refer to an estimated/approximated location of an RF device, an RF device is within a threshold distance/radius, and/or the accuracy of the positioning is within certain degree threshold (e.g., within certain degree of accuracy), etc.

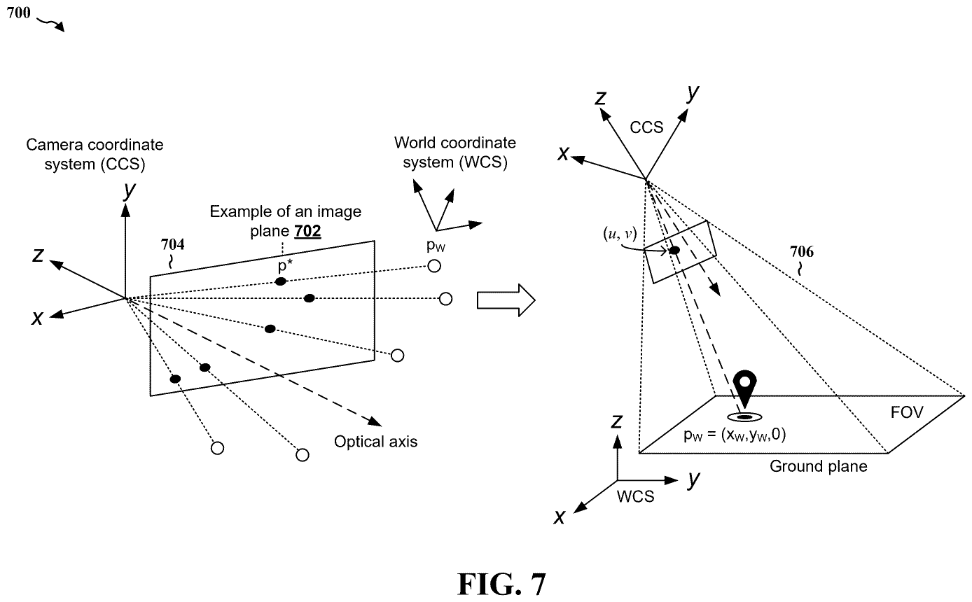

FIG. 7 is a diagram 700 illustrating an example projective transformation in accordance with various aspects of the present disclosure. In one example, parameters that may be used for determining the projection of world points of one or more objects onto an image plane 702 may include external parameters such as the camera pose (e.g., the position and the orientation of a camera) with regard to the world coordinate system (WCS) and internal parameters such as the focal length, size, resolution, skew, and/or distortion, etc. of the camera.

The projective transformation may be a linear operation in homogenous coordinates, represented by a calibration matrix M of size 3×4:

$${p}^{*} = M \cdot {p}_{W} and {\underbrace{s [ \begin{matrix}u \\ v \\ 1\end{matrix} ]}}_{{p}^{*}} = {\underbrace{[ \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34}\end{matrix} ]}}_{M} \cdot {\underbrace{[ \begin{matrix}{x}_{W} \\ {y}_{W} \\ {z}_{W} \\ 1\end{matrix} ]}}_{{p}_{W}}$$

where pw may indicate the world point of an object (e.g., the WCS of the object) and p* may indicate pixel point of the object on the image plane 702, such as shown at 704. This may be valid up to a scale in homogenous coordinates. If the pixel coordinates of the world point pw is represented by (u, v), using the homogeneous vector p*, the following may be obtained:

u=p*[1]/s, v=p*[2]/s,

where p* is a vector and p*[1] and p*[2] may indicate the first the second elements of the that vector.

In some scenarios, camera calibration may be performed via geometric error minimization. For example, given a dataset [symbol] of matched training points:

$$𝒟 = {\{ {p}_{i}^{*} , {p}_{W , i} \}}_{i = 1}^{N}$$

the camera calibration matrix M may be found as:

$${min}_{M} {\sum }_{i = 1}^{N} {d}^{2} ( {p}_{i}^{*} , {Mp}_{W , i} )$$

where d (·,·) may indicate the Euclidean distance between the non-homogenous pixel coordinates and the projections of the world points on the image plane 702. The minimization may be iterative, where a suitable initialization for M may be given by a direct linear transform (DLT) (which may be a standard procedure). The training data may be normalized first (e.g., zero mean and fixed standard deviation), where the normalization may be performed on pixels and world coordinates separately. In some examples, a random sample consensus (RANSAC) (an iterative method for estimating a mathematical model from a data set that contains outliers) may be used to select a subset of training points in D that produce well-conditioned/best/most suitable estimate of M.

As shown at 706, once M is known, the projections of the world coordinates on a ground plane (e.g., z=0) may be computed from relevant pixels on the image plane 702. For example, the column corresponding to the coordinate may be removed to obtain square matrix M_{z} which can be inverted:

$$\begin{matrix}[ \begin{matrix}u \\ v \\ 1\end{matrix} ] = [ \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34}\end{matrix} ] [ \begin{matrix}{x}_{W} \\ {y}_{W} \\ 0 \\ 1\end{matrix} ] \\ = [ \begin{matrix}{m}_{11} & {m}_{12} & {m}_{14} \\ {m}_{21} & {m}_{22} & {m}_{24} \\ {m}_{31} & {m}_{32} & {m}_{34}\end{matrix} ] [ \begin{matrix}{x}_{W} \\ {y}_{W} \\ 1\end{matrix} ] \\ = {M}_{z} [ \begin{matrix}{x}_{W} \\ {y}_{W} \\ 1\end{matrix} ]\end{matrix}$$

$${\hat{p}}_{W} = s [ \begin{matrix}{\hat{x}}_{W} \\ {\hat{y}}_{W} \\ 1\end{matrix} ] = {M}_{z}^{- 1} [ \begin{matrix}u \\ v \\ 1\end{matrix} ]$$

Then, the ground plane coordinates of pixel (u, v) may be obtained based on:

\hat{x}_{W}=\hat{p}_{W}[1]/s, ŷ_{W}=\hat{p}_{W}[2]/s.

In some examples, if the z coordinate of an object is not on the ground plane, the z coordinate of the object may be determined using a technique that detects the object (e.g., a bounding box) on the image and then searches for the pixels where the projection of the vertical continuation of the bounding box intersects the detected ground plane on the image.

In one aspect of the present disclosure, the world points in a training dataset for camera calibration may be given by 3D locations of network devices that are in the FOV of a camera. For example, in case of UEs, VR glasses, cars, UAVs, and other mobile nodes, the world points may be given by estimated locations obtained via RF (e.g., via wireless communication). In case of base stations/TRPs (e.g., NBs), APs or other fixed infrastructure nodes, the world points may be given by their true locations. Also, in addition to a location server (e.g., an LMF), four types of nodes may be used in association with the camera calibration presented herein.

The first type of node is a network device with camera and RF capability (e.g., has the capability to perform wireless communication), which may be referred to as a “CamDev” for purposes of the present disclosure. A CamDev may be an RF-enabled device with a camera, where images obtained from the CamDev may be used for localizing world points of interest/objects that are in the FOV of the camera of the CamDev. In most scenarios, the projective transformation of the camera of a CamDev is not known, e.g., CamDev may be a UE, VR glasses, an UAV etc. that are mobile.

The second type of node is a cooperative network device with an RF capability (e.g., has the capability to perform wireless communication) participating in camera calibration for the CamDev, which may be referred to as a “CpRFDev” for purposes of the present disclosure. A CpRFDev may be an RF-enabled node whose world location (or an estimate of it) is known to the location server. In addition, the CpRFDevs are in the FOV of the CamDev, and their image pixels and world locations may be used cooperatively for camera calibration.

The third type of node are non-cooperative network devices that are not participating in the camera calibration of the CamDev, which may be referred to as a “NonCpRFDev” for purposes of the present disclosure. A NonCpRFDev may be any RF-enabled network device that does not participate in camera calibration. For example, a NonCpRFDev may be a node defined to capture notion of consent among RF-enabled network devices. For example, some devices/UEs (e.g., CpRFDevs) may not have the capability or unwillingness to participate the process of camera calibration as this may specify analysis and fusion of their measurements.

The fourth type of node is a non-RF enabled object (e.g., does not have the capability to perform wireless communication), which may be referred to as a “NonRFobj” for purposes of the present disclosure. For example, a NonRFobj may be any point of interest (e.g., walls, obstacles, items, objects without RF communication capability, etc.) in the FOV of the CamDev.

Aspects presented herein may enable a camera to be calibrated using data coming from a set of CpRFDevs and the measured pixels from an image coming from a CamDev, which may enable location estimates for CpRFDevs to be improved and/or location estimates for NonCpRFDevs and NonRFobj to be generated with higher accuracy, which may be a result of the fusion with the pixel information. For example, on a high level, during a fusion, the RF-based information may be fused with relevant pixels from an image which brings in the position information of a UE from the pixels. As a result, the UE may obtain improved position estimates using the calibrated camera.

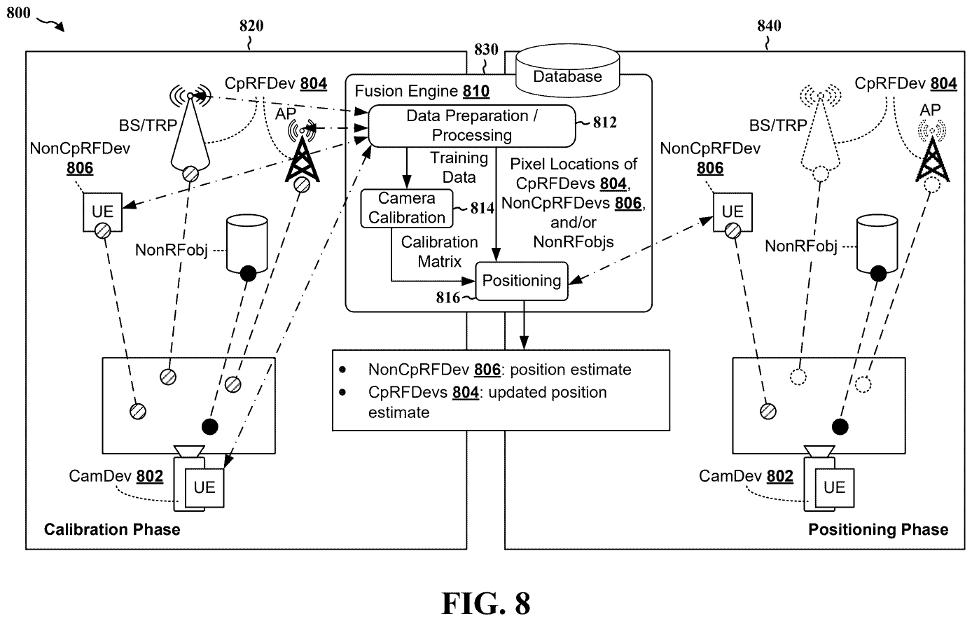

FIG. 8 is a diagram 800 illustrating an example of a fusion engine architecture associated with visual positioning in accordance with various aspects of the present disclosure. In one example, as shown at 820, a fusion engine 810 may receive image/pixels captured by a camera of a CamDev 802 (e.g., a UE with a camera) and the locations of one or more CpRFDevs 804 (e.g., base stations/TRPs, APs, etc.) that are in the FOV of the CamDev 802.

As shown at 830, the fusion engine 810 may include three main functional blocks. A first functional block 812 maybe associated with data preparation and processing (e.g., as described in connection with FIG. 7). In one example, the first functional block 812 may be responsible for procedure initiation (e.g., initialization of the visual positioning procedure). Depending on what type of node initiates the procedure (discussed in details below), the fusion engine 810 may determine a relevant CamDev (e.g., the CamDev 802) and/or a relevant set of CpRFDevs (e.g., the CpRFDevs 804), and the fusion engine 810 may allocate resources (e.g., time and/or frequency resources) specified for the information exchange (between different nodes), such as requests, responses, training data, and/or images, etc. In some scenarios, as the size of a UE (e.g., a CpRFDevs) may be small compare to a network entity (e.g., a base station). Thus, to detect the UE, the algorithm run by the fusion engine 810 may be configured to detect the object that carries the UE. For instance, this may be a pedestrian or an asset in warehouse. When a bounding box is produced, a reference pixel may be selected (e.g., in the case of a pedestrian, the reference pixel may be near the hand or the head of the pedestrian). In another example, the first functional block 812 may also be responsible for pixel location extraction, where the fusion engine 810 may extract the pixel locations of CpRFDevs 804, such as using an object detection mechanism. In some examples, to determine the correspondence between multiple UEs detected in an image and their locations, certain matching algorithms based on RANSAC may be used for this purpose. The matching may be a procedure preceding the camera calibration, and the algorithm may be configured to use off-the-shelf approaches. In another example, the first functional block 812 may also be responsible for matching, where the fusion engine 810 may match the world locations/coordinates (e.g., WCS coordinates) of the CpRFDevs 804 that are in the FOV of the CamDev 802 and their corresponding image pixel locations. In another example, the first functional block 812 may also be responsible data normalization (e.g., standardization, whitening, etc.), where in each domain, the fusion engine 810 may normalize the world locations and image separately. In one aspect, a purpose of the data normalization is to make the range of data variation in the world and image domains equal, such that the estimation/calibration problem may be well-posed. Standardization may be commonly used in camera calibration. There may also be two domains for the fusion engine 810, where the first domain is the world coordinate system domain where the location is measured in world coordinates (e.g., in meters), and the second domain is the image coordinate system domain where the location is measured in pixel locations on the image.

A second functional block 814 may be associated with camera calibration, such as described in connection with FIG. 7. In one example, the second functional block 814 may be responsible for outlier rejection, where the fusion engine 810 may perform training point selection such as using RANSAC. In another example, the second functional block 814 may also be responsible for projective transformation (calibration matrix) estimation. As shown at 820, during a calibration phase, the procedure (e.g., the visual positioning procedure) is initiated, communication channels are established, and specified data is exchanged. Also, the data may be prepared/preprocessed, and the camera may be calibrated.

A third functional block 816 may be associated with positioning, such as described in connection with FIG. 7. In one example, the third functional block 816 may enable the fusion engine 810 to compute position updates of cooperating CpRFDevs 804 and/or position estimates of NonCpRFDev(s) 806 based on the image pixel locations. As shown at 840, during a positioning phase, world locations from pixels may be estimated and disseminated to relevant devices/applications. The position data of CpRFDevs may be used as training data updates. In some examples, the estimated position may be more accurate than the position in the training data, such as in the depth direction. This may be a result/consequence of the fusion with the position information coming from the relevant pixel locations on the image.

In one aspect, the fusion engine 810 may be implemented based on a centralized mode or a decentralized mode. Under the centralized mode, which may be referred to as UE-assisted visual positioning, apart from pixel extraction in privacy-aware implementations, all functions (e.g., functions performed by functional blocks 812, 814, and 816) may be implemented on a server (e.g., a location server, an LMF, a learning management system (LMS), etc.). The centralized mode may be suitable for lightweight devices (e.g., UEs with reduced capabilities) as their processing power may be limited. Under the decentralized mode, which may be referred to as UE-based visual positioning, apart from certain functions performed by the first functional block 812 (such as procedure initiation and matching), remaining functions may be implemented on the UE side.

The visual positioning procedure described in connection with FIG. 8 may be initiated by different types of nodes, such as triggered/on-demand initiated by a CamDev (e.g., the CamDev 802), a CpRFDev (e.g., the CpRFDev 804), and/or a NonCpRFDev (e.g., the NonCpRFDev 806), etc.

If the visual positioning procedure is initiated by a CpRFDev or a NonCpRFDev (collectively as an “RFDev” hereafter), the RFDev (e.g., either a CpRFDev or a NonCpRFDev) may send a message to a server (e.g., a location server, an LMF, etc.) requesting a location estimate. A NonCpRFDev may explicitly indicate that it will not participate in the camera calibration through a dedicated field. For example, a default of this dedicated field may be set to 1 for a CpRFDev and set to 0 for a NonCpRFDev. The rest of the visual positioning procedure may remain the same for both the CpRFDev and the NonCpRFDev.

Using the approximate RF-based estimates of CpRFDevs locations, the server may find an active CamDev in the region. For example, such information may be stored and retrieved from a database (e.g., UAV surveillance may be an example use case). As an alternative, a CamDev may also be determined based on its proximity to CpRFDevs using the approximate location estimates (e.g., extended reality (XR)/VR or smartphone applications may be example use cases). In some examples, as FOV of CamDev is to be considered when a server is configured to find an appropriate CamDev, the server may determine the FOV of the CamDev using a variety of techniques. In one example, to determine the FOV for a CamDev (e.g., a mobile device such as a UE or XR/VR glasses), additional heading information associated with the CamDev may be used (e.g., coming from the associated IMU(s). By combining heading information of the CamDev with the relative location of the camera on the CamDev as well as the coarse location information available through RF, an approximate FOV of the CamDev may be determined.

On the other hand, if the visual positioning procedure is initiated by a CamDev, the CamDev may send a message to a server (e.g., a location server, an LMF, etc.) requesting its calibration matrix. Then, based on the region that is covered by the, the server may determine one or more CpRFDevs in the vicinity. Similarly, the server may determine the one or more CpRFDevs based on information stored in a database (e.g., UAV surveillance may be an example use case). As an alternative, the server may also determine the one or more CpRFDevs based on their proximity to the CamDev, such as using approximate location estimates (e.g., extended reality (XR)/VR or smartphone applications may be example use cases).

As discussed in connection with FIG. 8, depending on where the fusion engine functions are performed (e.g., functions performed in association with functional blocks 812, 814, and 816), the visual positioning may be UE-assisted or UE-based. For UE-assisted visual positioning, after visual positioning procedure initiation, the server may ping (e.g., notify, message, etc.) a CamDev, which in turn may send an image or a list of relevant pixel locations of the CpRFDevs to the server. In response, the server may then perform the remaining functions, such as processing the data, calibrating the camera using RF-based location estimates for the CpRFDevs, producing visual-based location estimates, and sending them to the initiating device(s). For UE-based visual positioning, after visual positioning procedure initiation, the server may ping (e.g., notify, message, etc.) a CamDev, which in turn may send an image or list of relevant pixel locations to the server. In response, the server may then send a list of matched pairs between pixels and CpRFDevs to the initiating device(s) which may execute remaining functions.

In another aspect of the present disclosure, aspects presented herein may also account for privacy awareness when a CamDev is specified to share visual data with a server. In one example (or under a first option), the CamDev may be configured to send an entire image to the server, and the server may perform the function of extracting relevant pixels. Such configuration may have the advantage of having a potentially more reliable matching due to the rich information present in the image. In another example (or under a second option), the CamDev may be configured to send just locations of relevant pixels to the server, where the CamDev may perform the function of relevant pixel extraction. Such configuration may have the advantage of increased privacy (e.g., the server does not have access to the actual visual context in which the CamDev is observing). In some implementations, the matching function may be configured to be performed on the server regardless which option is adopted, because (1) matching can be computationally demanding, and (2) the server may have access to more environmental information that can assist with matching relevant objects/pixels on the image with CpRFDevs' RF-based locations.

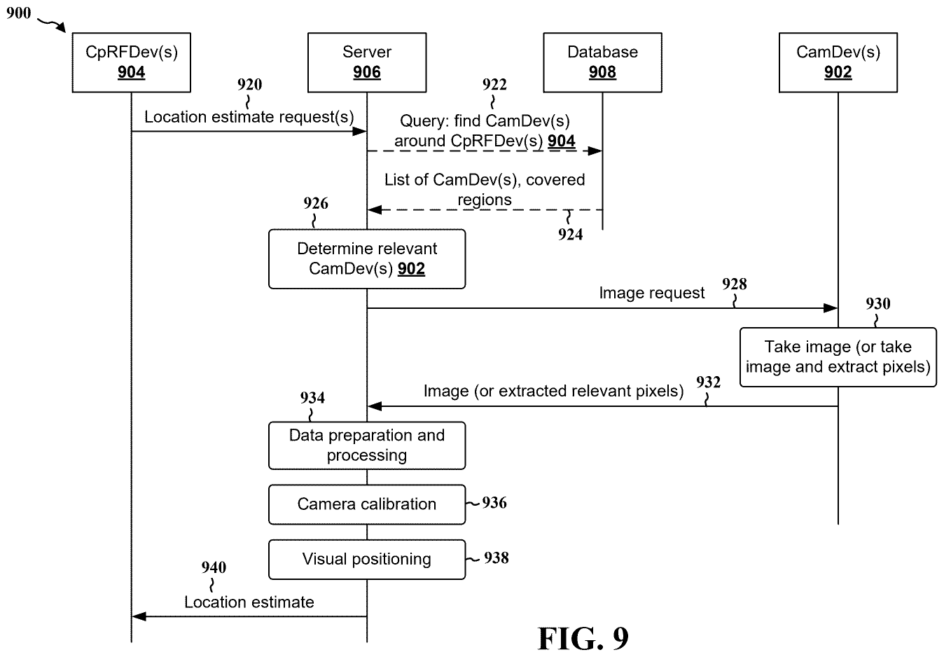

FIG. 9 is a communication flow 900 illustrating an example procedure of a CpRFDev initiating UE-assisted visual positioning in accordance with various aspects of the present disclosure. The numberings associated with the communication flow 900 do not specify a particular temporal order and are merely used as references for the communication flow 900.

At 920, a CpRFDev 904 that is configured to perform or participate in a UE-assisted visual positioning session (e.g., for determining/estimating the location of one or more objects in a region) may transmit a location estimate request to a server 906. As discussed in connection with FIG. 8, the CpRFDev 904 may be a cooperative network device with an RF capability (e.g., a UE, a base station/TRP, or a network node, etc. with the capability to perform wireless communication) participating in camera calibration for a CamDev. The server 906 may be a location server or an LMF. In one example, under the UE-assisted visual positioning, apart from pixel extraction in privacy-aware implementations, most functions (e.g., functions performed by functional blocks 812, 814, and 816 of FIG. 8) may be implemented on the server 906.

The location (or the estimated location) of the CpRFDev 904 may be known to the server 906. If the server 906 does not know the location of the CpRFDev 904, the server 906 may inquire the CpRFDev 904 (or a database), and the CpRFDev 904 may indicate its location to the server 906 (or the database may provide the location to the server 906). In some examples, if the CpRFDev 904 is a mobile device (e.g., a UE), the location of the CpRFDev 904 may be an approximate location (e.g., obtained via GNSS-based positioning, network-based positioning, etc. by the CpRFDev 904). If the CpRFDev 904 is a stationary device (e.g., a base station, a TRP, a roadside unit (RSU), etc.), the location of the CpRFDev 904 may be a true (e.g., exact) location.

In one example, at 922, in response to the location estimate request from the CpRFDev 904, the server 906 may transmit a query to a database 908 to find a list of CamDevs that are around the CpRFDev 904. For example, the database 908 may maintain a set of CamDevs with known locations, and the database 908 may select the list of CamDevs that are around the CpRFDev 904 based on their locations or distances to the CpRFDev 904. Then, at 924, the database 908 may transmit the list of CamDevs around the CpRFDev 904 (and also their covered regions) to the server 906 in response to the query.

At 926, the server 906 may determine a relevant CamDev 902 for participating in the UE-assisted visual positioning session. For example, the server 906 may select a CamDev in which the CpRFDev 904 (and also the one or more objects and/or the region to be detected) are in the FOV of the CamDev 902. In some examples, for a server to obtain (or to be notified for) the FOV of a CamDev, the server may determine an approximate FOV based on the reports coming from other devices. For example, in many mobile applications, such as smartphones and VR/XR, a device may report measurements from multiple sensors such as RF modules and IMUs which may be used to determine the direction in which the camera is looking. As described in connection with FIG. 8, the CamDev 902 may be a network device with at least a camera and an RF capability (e.g., a UE, a base station/TRP, or a network node, etc. with the capability to perform wireless communication). For example, the CamDev 902 may be an RF-enabled device with a camera, where images obtained from the CamDev 902 may be used for localizing world points (e.g., WCS coordinates, latitude and longitude coordinates, 2D/3D coordinates, etc.) of one or more objects that are in the FOV of the camera of the CamDev 902.

At 928, after the server 906 determines the CamDev 902 to be participated in the UE-assisted visual positioning, the server 906 may transmit an image request to the CamDev 902 to request the CamDev 902 to take image(s) (e.g., capture the FOV of the CamDev 902).

At 930, based on the image request, the CamDev 902 may take one or more images (e.g., based on its FOV). In some implementations, the CamDev 902 may also be configured to extract relevant pixels from the image(s) taken. Relevant pixels may refer to pixels/features that are likely to be useful/descriptive for the visual positioning, such as pixels of one or more objects and the CpRFDev 904 captured by the CamDev 902. In some examples, relevant pixels may be obtained by removing irrelevant pixels, such as pixels/features that are not descriptive, e.g., pixels/features that are less likely to be useful for the visual positioning, such as background, nature objects (e.g., sun, sky, cloud, etc.), reflections, blurry objects, etc. Then, at 932, the CamDev 902 may send the image(s) taken and/or the extracted relevant pixels (if performed by the CamDev 902) to the server 906.

At 934, based on the image(s) and/or the extracted relevant pixels from the CamDev 902, the server 906 may perform data preparation and processing for the image(s) and/or the extracted relevant pixels, such as described in connection with the first functional block 812 of FIG. 8. For example, data preparation and processing may include:
(1) visual positioning procedure initiation,
(2) determining relevant CamDev(s) and/or CpRFDev(s) for the visual positioning (e.g., if not performed at other steps),
(3) allocating resources specified for the information exchange between different nodes (e.g., between CamDev(s), CpRFDev(s) and the server) (e.g., if not performed at other steps),
(4) pixel location extraction (e.g., extracting the pixel location of the CpRFDev 904, such as using an object detection mechanism,
(5) matching (e.g., matching the world locations (e.g., WCS/2D/3D coordinates) of the CpRFDev 904 in the FOV of the CamDev 902 and their corresponding image pixel locations,
(6) data normalization (e.g., standardization, whitening, etc.), or
(7) a combination thereof.

At 936, the server 906 may perform camera calibration based on the data preparation and processing, such as described in connection with the second functional block 814 of FIG. 8. For example, camera calibration may include outlier rejection (e.g., performing training point selection, such as using RANSAC), and/or projective transformation (calibration matrix) estimation as described in connection with FIGS. 5 to 7.

At 938, after performing the camera calibration, the server 906 may perform the visual positioning (e.g., the UE-assisted visual positioning) for one or more objects in the image(s) taken (or in the extracted relevant pixels), such as described in connection with the third functional block 816 of FIG. 8. For example, visual positioning may include computing position updates of the CpRFDev 904 (and/or the position estimates of NonCpRFDev(s)) based on the image pixel locations, estimating world locations of one or more objects from pixels, and/or disseminating the estimated locations of the one or more objects to relevant devices/applications. For example, at 940, the server 906 may transmit the result of the visual positioning to the CpRFDev 904, such as the location estimates of one or more objects detected within the FOV of the CamDev 902 (e.g., estimated locations of CpRFDev(s), NonCpRFDev(s), NonRFobj(s), etc.).

The UE-assisted visual positioning described in connection with FIG. 9 may be suitable for CpRFDev(s) with limited (or low) processing power, such as UEs with reduced capabilities and lightweight devices.

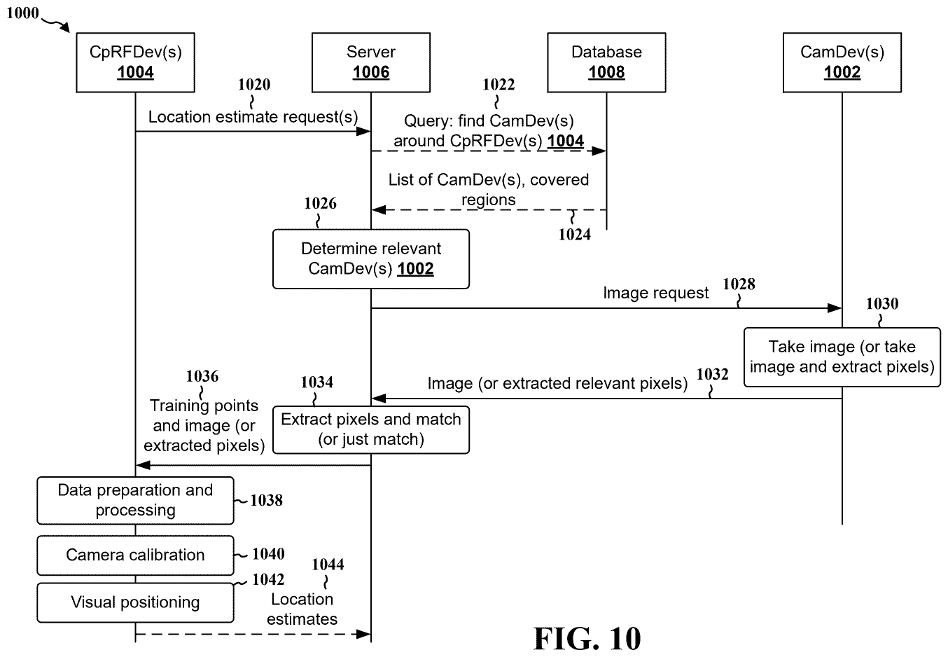

FIG. 10 is a communication flow 1000 illustrating an example procedure of a CpRFDev initiating UE-based visual positioning in accordance with various aspects of the present disclosure. The numberings associated with the communication flow 1000 do not specify a particular temporal order and are merely used as references for the communication flow 1000.

At 1020, a CpRFDev 1004 that is configured to perform or participate in a UE-based visual positioning session (e.g., for determining/estimating the location of one or more objects in a region) may transmit a location estimate request to a server 1006. As discussed in connection with FIG. 8, the CpRFDev 1004 may be a cooperative network device with an RF capability (e.g., a UE, a base station/TRP, or a network node, etc. with the capability to perform wireless communication) participating in camera calibration for a CamDev. The server 1006 may be a location server or an LMF. In one example, under the UE-based visual positioning, most functions associated with the visual positioning may be implemented on (e.g., performed by) the CpRFDev 1004. For example, apart from certain functions performed by the first functional block 812 of FIG. 8 (e.g., initiation and matching), remaining functions performed by functional blocks 812, 814, and 816 may be implemented on the CpRFDev 1004.

The location (or the estimated location) of the CpRFDev 1004 may be known to the server 1006. If the server 1006 does not know the location of the CpRFDev 1004, the server 1006 may inquire the CpRFDev 1004 (or a database), and the CpRFDev 1004 may indicate its location to the server 1006 (or the database may provide the location of the CpRFDev 1004 to the server 1006). In some examples, if the CpRFDev 1004 is a mobile device (e.g., a UE), the location of the CpRFDev 1004 may be an approximate location (e.g., obtained via GNSS-based positioning, network-based positioning, etc. by the CpRFDev 1004). If the CpRFDev 1004 is a stationary device (e.g., a base station, a TRP, a roadside unit (RSU), etc.), the location of the CpRFDev 1004 may be a true (e.g., exact) location.

In one example, at 1022, in response to the location estimate request from the CpRFDev 1004, the server 1006 may transmit a query to a database 1008 to find a list of CamDevs that are around the CpRFDev 1004. For example, the database 1008 may maintain a set of CamDevs with known locations, and the database 1008 may select the list of CamDevs that are around the CpRFDev 1004 based on their locations or distances to the CpRFDev 1004. Then, at 1024, the database 1008 may transmit the list of CamDevs around the CpRFDev 1004 (and also their covered regions) to the server 1006 in response to the query.

At 1026, the server 1006 may determine a relevant CamDev 1002 for participating in the UE-based visual positioning session. For example, the server 1006 may select a CamDev in which the CpRFDev 1004 (and also the one or more objects and/or the region to be detected) are in the FOV of the CamDev 1002. As described in connection with FIG. 8, the CamDev 1002 may be a network device with at least a camera and an RF capability (e.g., a UE, a base station/TRP, or a network node, etc. with the capability to perform wireless communication). For example, the CamDev 1002 may be an RF-enabled device with a camera, where images obtained from the CamDev 1002 may be used for localizing world points (e.g., WCS coordinates, latitude and longitude coordinates, 2D/3D coordinates, etc.) of one or more objects that are in the FOV of the camera of the CamDev 1002.

At 1028, after the server 1006 determines the CamDev 1002 to be participated in the UE-based visual positioning, the server 1006 may transmit an image request to the CamDev 1002 to request the CamDev 1002 to take image(s) (e.g., capture the FOV of the CamDev 1002).

At 1030, based on the image request, the CamDev 1002 may take one or more images (e.g., based on its FOV). In some implementations, the CamDev 1002 may also be configured to extract relevant pixels from the image(s) taken. Relevant pixels may refer to pixels/features that are likely to be useful/descriptive for the visual positioning, such as pixels of one or more objects and the CpRFDev 1004 captured by the CamDev 1002. In some examples, relevant pixels may be obtained by removing irrelevant pixels, such as pixels/features that are not descriptive, e.g., pixels/features that are less likely to be useful for the visual positioning, such as background, nature objects (e.g., sun, sky, cloud, etc.), reflections, blurry objects, etc. Then, at 1032, the CamDev 1002 may send the image(s) taken and/or the extracted relevant pixels (if performed by the CamDev 1002) to the server 1006.

At 1034, if the CamDev 1002 is not configured to perform the extraction of relevant pixels from the image(s) taken, the server 1006 may be configured to perform the extraction of pixel(s) instead. Then, the server 1006 may perform matching for locations of one or more objects in the image(s) taken (or in the extracted relevant pixels) with their pixel locations. For example, the server 1006 may match the world locations (e.g., WCS/2D/3D coordinates) of the CpRFDev 1004 (or multiple CpRFDev(s)) in the FOV of the CamDev 1002 and their corresponding image pixel locations. If the CamDev 1002 is configured to perform the extraction of relevant pixels from the image(s) taken, then the server 1006 may just perform the matching. Then, at 1036, the server 1006 may send a set of training points (obtained from the matching as described in connection with FIG. 7) and also the image(s) taken (or the extracted relevant pixels) to the CpRFDev 1004.

At 1038, based on the training points and the image(s) taken (or the extracted relevant pixels) from the server 1006, the CpRFDev 1004 may perform data preparation and processing for the image(s) and/or the extracted relevant pixels, such as described in connection with the first functional block 812 of FIG. 8. For example, data preparation and processing may include:
(1) determining relevant CamDev(s) and/or CpRFDev(s) for the visual positioning (e.g., if not performed at other steps),
(2) allocating resources specified for the information exchange between different nodes (e.g., between CamDev(s), CpRFDev(s) and the server) (e.g., if not performed at other steps),
(3) pixel location extraction (e.g., extracting the pixel location of the CpRFDev 1004, such as using an object detection mechanism,
(4) data normalization (e.g., standardization, whitening, etc.), or
(5) a combination thereof.

At 1040, the CpRFDev 1004 may perform camera calibration based on the data preparation and processing, such as described in connection with the second functional block 814 of FIG. 8. For example, camera calibration may include outlier rejection (e.g., performing training point selection, such as using RANSAC), and/or projective transformation (calibration matrix) estimation as described in connection with FIGS. 5 to 7.

At 1042, after performing the camera calibration, the CpRFDev 1004 may perform the visual positioning (e.g., the UE-based visual positioning) for one or more objects in the image(s) taken (or in the extracted relevant pixels), such as described in connection with the third functional block 816 of FIG. 8. For example, visual positioning may include computing position updates of the CpRFDev 1004 (and/or the position estimates of NonCpRFDev(s)) based on the image pixel locations, estimating world locations of one or more objects from pixels, and/or disseminating the estimated locations of the one or more objects to relevant devices/applications. For example, at 1044, the CpRFDev 1004 may transmit the result of the visual positioning to the server 1006 (if specified), such as the location estimates of one or more objects detected within the FOV of the CamDev 1002 (e.g., estimated locations of CpRFDev(s), NonCpRFDev(s), NonRFobj(s), etc.).

The UE-based visual positioning described in connection with FIG. 10 may be suitable for CpRFDev(s) with higher processing power, such as a TRP, a base station, or a high-performance UE, etc.

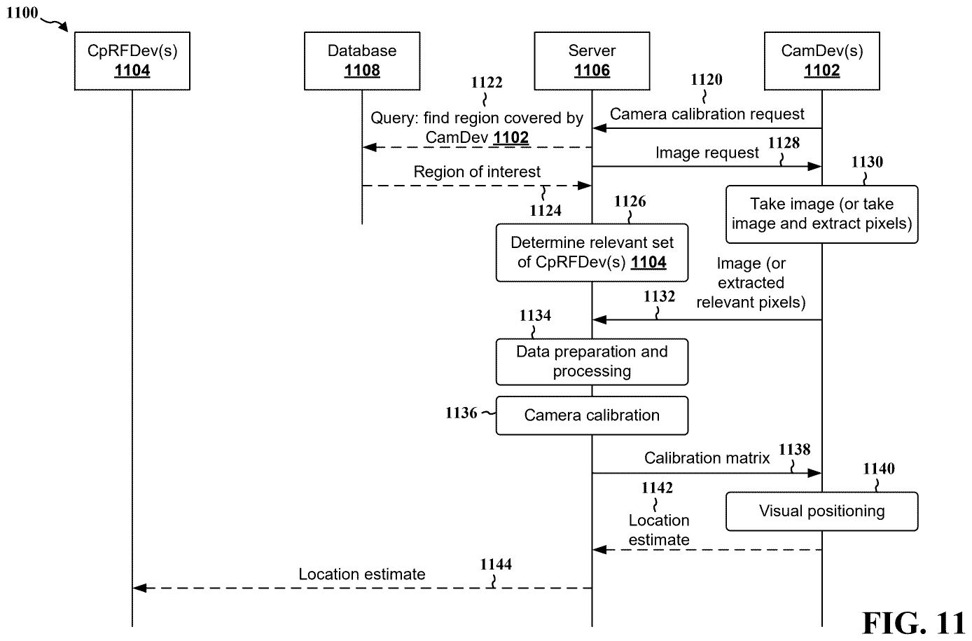

FIG. 11 is a communication flow 1100 illustrating an example procedure of a CamDev initiating UE-assisted visual positioning in accordance with various aspects of the present disclosure. The numberings associated with the communication flow 1100 do not specify a particular temporal order and are merely used as references for the communication flow 1100.

At 1120, a CamDev 1102 that is configured to perform or participate in a UE-assisted visual positioning session (e.g., for determining/estimating the location of one or more objects in the FOV of the CamDev 1102) may transmit a camera calibration request to a server 1106. As described in connection with FIG. 8, the CamDev 1102 may be a network device with at least a camera and an RF capability (e.g., a UE, a base station/TRP, or a network node, etc. with the capability to perform wireless communication). For example, the CamDev 1102 may be an RF-enabled device with a camera, where images obtained from the CamDev 1102 may be used for localizing world points (e.g., WCS coordinates, latitude and longitude coordinates, 2D/3D coordinates, etc.) of one or more objects that are in the FOV of the camera of the CamDev 1102. The server 1106 may be a location server or an LMF. In one example, under the UE-assisted visual positioning, apart from pixel extraction in privacy-aware implementations, most functions (e.g., functions performed by functional blocks 812, 814, and 816 of FIG. 8) may be implemented on the server 1106.

In one example, at 1122, in response to the camera calibration request from the CamDev 1102, the server 1106 may transmit a query to a database 1108 to find regions covered by the CamDev 1102. For example, the database 1108 may maintain a set of regions with different CpRFDevs located, and the database 1108 may select a list of regions that are around the CamDev 1102 based on their locations or distances to the CamDev 1102. Then, at 1124, the database 1108 may transmit the list of regions (e.g., region of interest) around the CamDev 1102 (and the associated CpRFDevs in each region) to the server 1106 in response to the query.

At 1126, the server 1106 may determine a set of relevant CpRFDevs 1104 for participating in the UE-assisted visual positioning session. For example, the server 1106 may select a set of CpRFDevs that are in the FOV of the CamDev 1102. As discussed in connection with FIG. 8, the set of relevant CpRFDevs 1104 may be cooperative network devices with an RF capability (e.g., UEs, base stations/TRPs, or network nodes, etc. with the capability to perform wireless communication) that are able to participate in the camera calibration for the CamDev 1102.

The locations (or the estimated locations) of the set of relevant CpRFDevs 1104 may be known to the server 1106. If the server 1106 does not know the location of a CpRFDev, the server 1106 may inquire the CpRFDev, and the CpRFDev may indicate its location to the server 1106. In some examples, if a CpRFDev is a mobile device (e.g., a UE), the location of the CpRFDev may be an approximate location (e.g., obtained via GNSS-based positioning, network-based positioning, etc.). If a CpRFDev is a stationary device (e.g., a base station, a TRP, a roadside unit (RSU), etc.), the location of the CpRFDev may be a true (e.g., exact) location.

At 1128, the server 1106 may transmit an image request to the CamDev 1102 to request the CamDev 1102 to take image(s) (e.g., capture the FOV of the CamDev 1102).

At 1130, based on the image request, the CamDev 1102 may take one or more images (e.g., based on its FOV). In some implementations, the CamDev 1102 may also be configured to extract relevant pixels from the image(s) taken. Relevant pixels may refer to pixels/features that are likely to be useful/descriptive for the visual positioning, such as pixels of one or more objects and the set of relevant CpRFDevs 1104 captured by the CamDev 1102. In some examples, relevant pixels may be obtained by removing irrelevant pixels, such as pixels/features that are not descriptive, e.g., pixels/features that are less likely to be useful for the visual positioning, such as background, nature objects (e.g., sun, sky, cloud, etc.), reflections, blurry objects, etc. Then, at 1132, the CamDev 1102 may send the image(s) taken and/or the extracted relevant pixels (if performed by the CamDev 1102) to the server 1106.

At 1134, based on the image(s) and/or the extracted relevant pixels from the CamDev 1102, the server 1106 may perform data preparation and processing for the image(s) and/or the extracted relevant pixels, such as described in connection with the first functional block 812 of FIG. 8. For example, data preparation and processing may include:
(1) visual positioning procedure initiation,
(2) determining relevant CamDev(s) and/or CpRFDev(s) for the visual positioning (e.g., if not performed at other steps),
(3) allocating resources specified for the information exchange between different nodes (e.g., between CamDev(s), CpRFDev(s) and the server) (e.g., if not performed at other steps),
(4) pixel location extraction (e.g., extracting the pixel location of the set of relevant CpRFDevs 1104, such as using an object detection mechanism,
(5) matching (e.g., matching the world locations (e.g., WCS/2D/3D coordinates) of the set of relevant CpRFDevs 1104 in the FOV of the CamDev 1102 and their corresponding image pixel locations,
(6) data normalization (e.g., standardization, whitening, etc.), or
(7) a combination thereof.

At 1136, the server 1106 may perform camera calibration based on the data preparation and processing, such as described in connection with the second functional block 814 of FIG. 8. For example, camera calibration may include outlier rejection (e.g., performing training point selection, such as using RANSAC), and/or projective transformation (calibration matrix) estimation as described in connection with FIGS. 5 to 7. Then, at 1138, the server 1106 may transmit a calibration matrix (associated with or obtained from the camera calibration) to the CamDev 1102.

At 1140, based on the calibration matrix from the server 1106, the CamDev 1102 may perform the visual positioning (e.g., the UE-assisted visual positioning) for one or more objects in the image(s) taken (or in the extracted relevant pixels), such as described in connection with the third functional block 816 of FIG. 8. For example, visual positioning may include computing position updates of the set of relevant CpRFDevs 1104 (and/or the position estimates of NonCpRFDev(s)) based on the image pixel locations, estimating world locations of one or more objects from pixels, and/or disseminating the estimated locations of the one or more objects to relevant devices/applications. For example, at 1142, the CamDev 1102 may transmit the result of the visual positioning to the server 1106, such as the location estimates of one or more objects detected within the FOV of the CamDev 1102 (e.g., estimated locations of CpRFDev(s), NonCpRFDev(s), NonRFobj(s), etc.). In some examples, at 1144, the server 1106 may also transmit/forward the location estimates of the one or more objects detected within the FOV of the CamDev 1102 to the set of relevant CpRFDevs 1104.

The UE-assisted visual positioning described in connection with FIG. 11 may be suitable for CamDev(s) with limited (or low) processing power, such as UEs with reduced capabilities and lightweight devices.

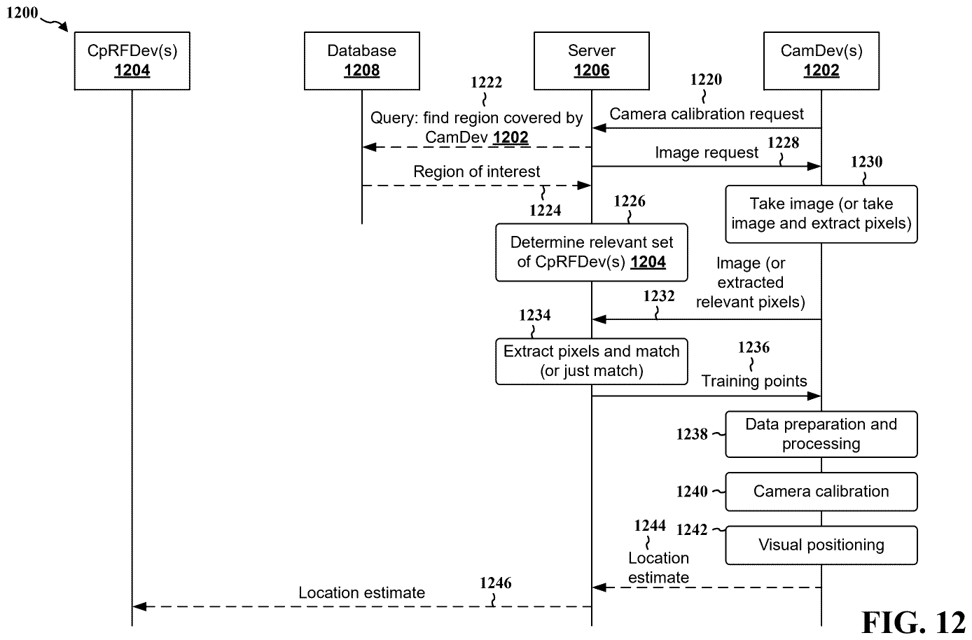

FIG. 12 is a communication flow 1200 illustrating an example procedure of a CamDev initiating UE-based visual positioning in accordance with various aspects of the present disclosure. The numberings associated with the communication flow 1200 do not specify a particular temporal order and are merely used as references for the communication flow 1200.

At 1220, a CamDev 1202 that is configured to perform or participate in a UE-based visual positioning session (e.g., for determining/estimating the location of one or more objects in the FOV of the CamDev 1202) may transmit a camera calibration request to a server 1206. As described in connection with FIG. 8, the CamDev 1202 may be a network device with at least a camera and an RF capability (e.g., a UE, a base station/TRP, or a network node, etc. with the capability to perform wireless communication). For example, the CamDev 1202 may be an RF-enabled device with a camera, where images obtained from the CamDev 1202 may be used for localizing world points (e.g., WCS coordinates, latitude and longitude coordinates, 2D/3D coordinates, etc.) of one or more objects that are in the FOV of the camera of the CamDev 1202. The server 1206 may be a location server or an LMF. In one example, under the UE-based visual positioning, most functions associated with the visual positioning may be implemented on (e.g., performed by) the CamDev 1202. For example, apart from certain functions performed by the first functional block 812 of FIG. 8 (e.g., initiation and matching), remaining functions performed by functional blocks 812, 814, and 816 may be implemented on the CamDev 1202.

In one example, at 1222, in response to the camera calibration request from the CamDev 1202, the server 1206 may transmit a query to a database 1208 to find regions covered by the CamDev 1202. For example, the database 1208 may maintain a set of regions with different CpRFDevs located, and the database 1208 may select a list of regions that are around the CamDev 1202 based on their locations or distances to the CamDev 1202. Then, at 1224, the database 1208 may transmit the list of regions (e.g., region of interest) around the CamDev 1202 (and the associated CpRFDevs in each region) to the server 1206 in response to the query.

At 1226, the server 1206 may determine a set of relevant CpRFDevs 1204 for participating in the UE-based visual positioning session. For example, the server 1206 may select a set of CpRFDevs that are in the FOV of the CamDev 1202. As discussed in connection with FIG. 8, the set of relevant CpRFDevs 1204 may be cooperative network devices with an RF capability (e.g., UEs, base stations/TRPs, or network nodes, etc. with the capability to perform wireless communication) that are able to participate in the camera calibration for the CamDev 1202.

The locations (or the estimated locations) of the set of relevant CpRFDevs 1204 may be known to the server 1206. If the server 1206 does not know the location of a CpRFDev, the server 1206 may inquire the CpRFDev, and the CpRFDev may indicate its location to the server 1206. In some examples, if a CpRFDev is a mobile device (e.g., a UE), the location of the CpRFDev may be an approximate location (e.g., obtained via GNSS-based positioning, network-based positioning, etc.). If a CpRFDev is a stationary device (e.g., a base station, a TRP, a roadside unit (RSU), etc.), the location of the CpRFDev may be a true (e.g., exact) location.

At 1228, the server 1206 may transmit an image request to the CamDev 1202 to request the CamDev 1202 to take image(s) (e.g., capture the FOV of the CamDev 1202).

At 1230, based on the image request, the CamDev 1202 may take one or more images (e.g., based on its FOV). In some implementations, the CamDev 1202 may also be configured to extract relevant pixels from the image(s) taken. Relevant pixels may refer to pixels/features that are likely to be useful/descriptive for the visual positioning, such as pixels of one or more objects and the set of relevant CpRFDevs 1204 captured by the CamDev 1202. In some examples, relevant pixels may be obtained by removing irrelevant pixels, such as pixels/features that are not descriptive, e.g., pixels/features that are less likely to be useful for the visual positioning, such as background, nature objects (e.g., sun, sky, cloud, etc.), reflections, blurry objects, etc. Then, at 1232, the CamDev 1202 may send the image(s) taken and/or the extracted relevant pixels (if performed by the CamDev 1202) to the server 1206.

At 1234, if the CamDev 1202 is not configured to perform the extraction of relevant pixels from the image(s) taken, the server 1206 may be configured to perform the extraction of pixel(s) instead. Then, the server 1206 may perform matching for locations of one or more objects in the image(s) taken (or in the extracted relevant pixels) with their pixel locations. For example, the server 1206 may match the world locations (e.g., WCS/2D/3D coordinates) of the set of relevant CpRFDevs 1204 (or multiple CpRFDev(s)) in the FOV of the CamDev 1202 and their corresponding image pixel locations. If the CamDev 1202 is configured to perform the extraction of relevant pixels from the image(s) taken, then the server 1206 may just perform the matching. Then, at 1236, the server 1206 may send a set of training points (obtained from the matching as described in connection with FIG. 7) to the CamDev 1202.

At 1238, based on the training points from the server 1206 and the image(s) taken (or the relevant pixels extracted) by the CamDev 1202, the CamDev 1202 may perform data preparation and processing for the image(s) and/or the extracted relevant pixels, such as described in connection with the first functional block 812 of FIG. 8. For example, data preparation and processing may include:
(1) determining relevant CamDev(s) and/or CpRFDev(s) for the visual positioning (e.g., if not performed at other steps),
(2) allocating resources specified for the information exchange between different nodes (e.g., between CamDev(s), CpRFDev(s) and the server) (e.g., if not performed at other steps),
(3) pixel location extraction (e.g., extracting the pixel location of the set of relevant CpRFDevs 1204, such as using an object detection mechanism,
(4) data normalization (e.g., standardization, whitening, etc.), or
(5) a combination thereof.

At 1240, the CamDev 1202 may perform camera calibration based on the data preparation and processing, such as described in connection with the second functional block 814 of FIG. 8. For example, camera calibration may include outlier rejection (e.g., performing training point selection, such as using RANSAC), and/or projective transformation (calibration matrix) estimation as described in connection with FIGS. 5 to 7.

At 1242, after performing the camera calibration, the CamDev 1202 may perform the visual positioning (e.g., the UE-based visual positioning) for one or more objects in the image(s) taken (or in the extracted relevant pixels), such as described in connection with the third functional block 816 of FIG. 8. For example, visual positioning may include computing position updates of the set of relevant CpRFDevs 1204 (and/or the position estimates of NonCpRFDev(s)) based on the image pixel locations, estimating world locations of one or more objects from pixels, and/or disseminating the estimated locations of the one or more objects to relevant devices/applications. For example, at 1244, the CamDev 1202 may transmit the result of the visual positioning to the server 1206 (if specified), such as the location estimates of one or more objects detected within the FOV of the CamDev 1202 (e.g., estimated locations of CpRFDev(s), NonCpRFDev(s), NonRFobj(s), etc.). In some examples, at 1246, the server 1206 may also transmit/forward the location estimates of the one or more objects detected within the FOV of the CamDev 1202 to the set of relevant CpRFDevs 1204.

The UE-based visual positioning described in connection with FIG. 12 may be suitable for CamDev(s) with higher processing power, such as a TRP, a base station, or a high-performance UE, etc.

Aspects presented herein provide visual-based positioning that offers a high-accuracy position estimation, where coordinates of points of interest (such as positions of UEs or objects in a warehouse) can be computed from the corresponding pixels using the inverse of a projective transformation that maps world points onto the 2D image. The projective transformation may depend on the camera pose (position+orientation) and a set of camera parameters, and knowing the projective transformation (referred to as camera calibration) may be a key for reliable localization of objects of interest in the camera FOV. In one aspect, RF-based location estimates of network devices (UEs, APs, NBs, etc.) in the camera FOV may be used as scene features for camera calibration. A fusion engine may receive image/pixels from camera devices and the locations of the RF devices that are in the FOV. In various aspects, fusion engine may be centralized (UE-assisted visual positioning), or decentralized (UE-based visual positioning).

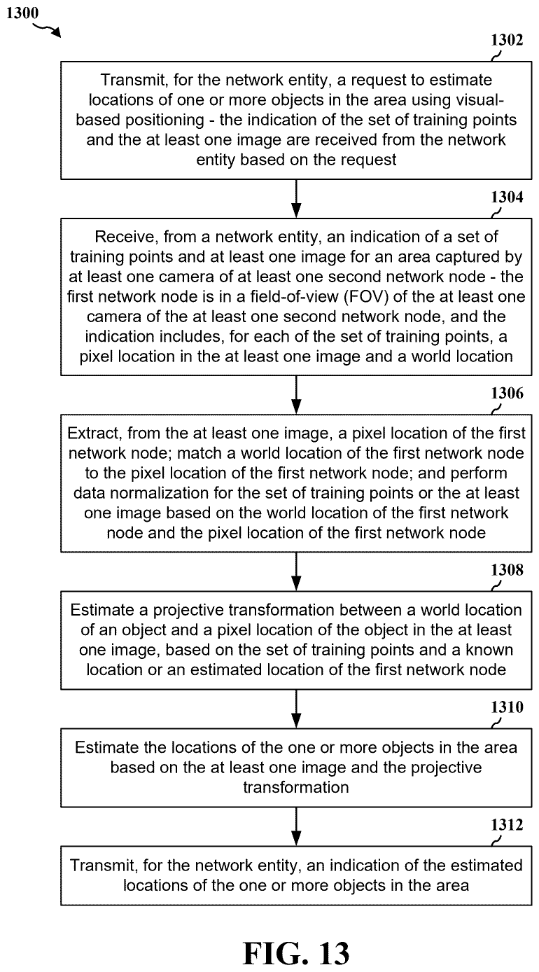

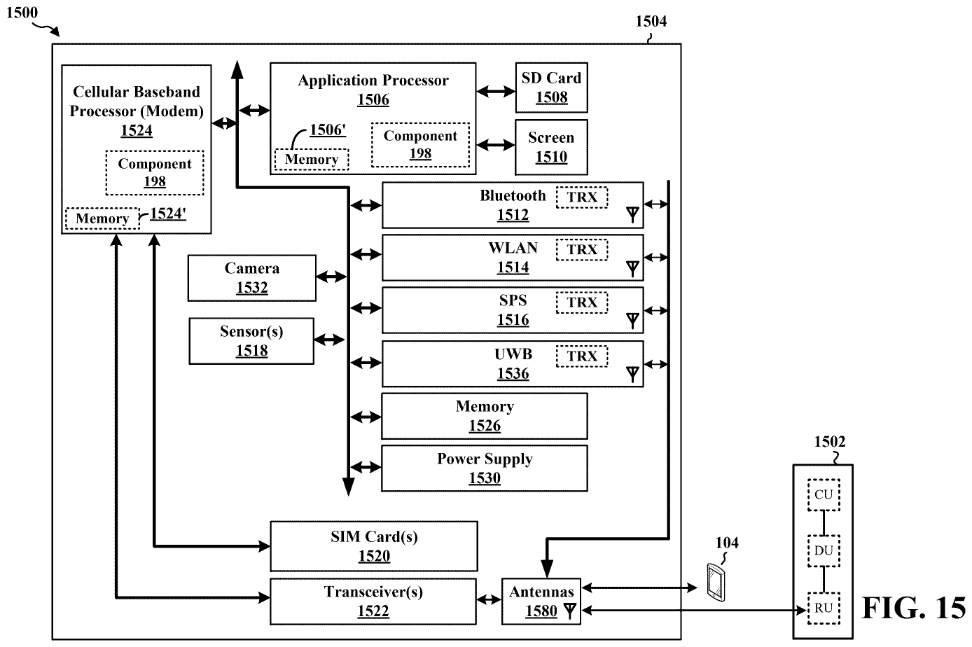

FIG. 13 is a flowchart 1300 of a method of wireless communication. The method may be performed by a first network node (e.g., the UE 104, 404; the camera 602; the CpRFDev 804, 904, 1004, 1104, 1204; the apparatus 1504 (discussed in connection with FIG. 15 below)). The method may enable the first network node (e.g., a UE) to initiate UE-assisted visual positioning or UE-based visual positioning with camera calibration performed based on network device(s) with known locations and RF capabilities.

At 1304, the first network node may receive, from a network entity, an indication of a set of training points and at least one image for an area captured by at least one camera of at least one second network node, where the first network node is in a FOV of the at least one camera of the at least one second network node, where the indication includes, for each of the set of training points, a pixel location in the at least one image and a world location, such as described in connection with FIG. 10. For example, at 1036, the CpRFDev 1004 may receive, from the server 1006, a set of training points (obtained from the matching as described in connection with FIG. 7) and also a set of image(s) for an area (or the extracted relevant pixels). The at least one image is taken by the CamDev 1002 and the CpRFDev 1004 is in the FOV of the CamDev. The reception of the set of training points and the at least one image may be performed by, e.g., the visual positioning component 198, the camera 1532, the application processor 1506, the cellular baseband processor 1524, and/or the transceiver(s) 1522 of the apparatus 1504 in FIG. 15.

In one example, as shown at 1302, the first network node may transmit, for the network entity, a request to estimate locations of one or more objects in the area using visual-based positioning, where the indication of the set of training points and the at least one image may be received from the network entity based on the request, such as described in connection with FIG. 10. For example, at 1020, a CpRFDev 1004 that is configured to perform or participate in a UE-based visual positioning session (e.g., for determining/estimating the location of one or more objects in a region) may transmit a location estimate request to a server 1006. The transmission of the request may be performed by, e.g., the visual positioning component 198, the camera 1532, the application processor 1506, the cellular baseband processor 1524, and/or the transceiver(s) 1522 of the apparatus 1504 in FIG. 15.

In another example, at 1306, the first network node may extract, from the at least one image, a pixel location of the first network node; match a world location of the first network node to the pixel location of the first network node; and perform data normalization for the set of training points or the at least one image based on the world location of the first network node and the pixel location of the first network node, such as described in connection with FIG. 10. For example, at 1038, based on the training points and the image(s) taken (or the extracted relevant pixels) from the server 1006, the CpRFDev 1004 may perform data preparation and processing for the image(s) and/or the extracted relevant pixels, such as described in connection with the first functional block 812 of FIG. 8. For example, data preparation and processing may include: (1) determining relevant CamDev(s) and/or CpRFDev(s) for the visual positioning, (2) allocating resources specified for the information exchange between different nodes (e.g., between CamDev(s), CpRFDev(s) and the server), (3) pixel location extraction (e.g., extracting the pixel location of the CpRFDev 1004, such as using an object detection mechanism, (4) data normalization (e.g., standardization, whitening, etc.), or (5) a combination thereof. The extraction of the pixel location of the first network node, the matching of the world location of the first network node to the pixel location of the first network node, and/or the data normalization for the set of training points or the at least one image may be performed by, e.g., the visual positioning component 198, the camera 1532, the application processor 1506, the cellular baseband processor 1524, and/or the transceiver(s) 1522 of the apparatus 1504 in FIG. 15. In some implementations, the pixel location of the first network node is extracted using object detection.

At 1308, the first network node may estimate a projective transformation between a world location of an object and a pixel location of the object in the at least one image, based on the set of training points and a known location or an estimated location of the first network node, such as described in connection with FIG. 10. For example, at 1040, the CpRFDev 1004 may perform camera calibration (e.g., projective transformation) based on the data preparation and processing, such as described in connection with the second functional block 814 of FIG. 8. For example, camera calibration may include outlier rejection (e.g., performing training point selection, such as using RANSAC), and/or projective transformation (calibration matrix) estimation as described in connection with FIGS. 5 to 7. The projective transformation may be performed by, e.g., the visual positioning component 198, the camera 1532, the application processor 1506, the cellular baseband processor 1524, and/or the transceiver(s) 1522 of the apparatus 1504 in FIG. 15. In some implementations, to estimate the projective transformation, the first network node may select a subset of training points from the set of training points, and generate a camera calibration matrix based on the subset of training points. In some implementations, the subset of training points may be selected from the set of training points based on a random sample consensus (RANSAC).

At 1310, the first network node may estimate the locations of the one or more objects in the area based on the at least one image and the projective transformation, such as described in connection with FIG. 10. For example, at 1042, after performing the camera calibration, the CpRFDev 1004 may perform the visual positioning (e.g., the UE-based visual positioning) for one or more objects in the image(s) taken (or in the extracted relevant pixels), such as described in connection with the third functional block 816 of FIG. 8. The estimation of the locations of the one or more objects in the area may be performed by, e.g., the visual positioning component 198, the camera 1532, the application processor 1506, the cellular baseband processor 1524, and/or the transceiver(s) 1522 of the apparatus 1504 in FIG. 15. In some implementations, to estimate the locations of the one or more objects in the area based on the at least one image and the projective transformation, the first network node may compute image pixel locations of the one or more objects based on the at least one image. In some implementations, the one or more objects in the area are in the FOV of the at least one camera of the at least one second network node.

In one example, the first network node may be a base station or a TRP including the known location.

In another example, the first network node may be a UE including the estimated location. In some implementations, the first network node may obtain the estimated location of the first network node based on network-based positioning or GNSS-based positioning.

In another example, the one or more objects may be non-radio frequency (non-RF) objects or the one or more objects do not include RF capabilities.

In another example, the visual-based positioning is UE-based visual positioning.

At 1312, the first network node may transmit, for the network entity, an indication of the estimated locations of the one or more objects in the area, such as described in connection with FIG. 10. For example, at 1044, the CpRFDev 1004 may transmit the result of the visual positioning to the server 1006 (if specified), such as the location estimates of one or more objects detected within the FOV of the CamDev 1002 (e.g., estimated locations of CpRFDev(s), NonCpRFDev(s), NonRFobj(s), etc.). The transmission of the indication of the estimated locations of the one or more objects in the area may be performed by, e.g., the visual positioning component 198, the camera 1532, the application processor 1506, the cellular baseband processor 1524, and/or the transceiver(s) 1522 of the apparatus 1504 in FIG. 15.

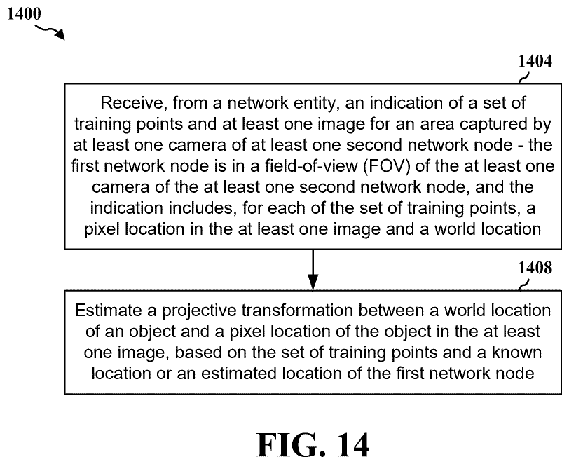

FIG. 14 is a flowchart 1400 of a method of wireless communication. The method may be performed by a first network node (e.g., the UE 104, 404; the camera 602; the CpRFDev 804, 904, 1004, 1104, 1204; the apparatus 1504 (discussed in connection with FIG. 15 below)). The method may enable the first network node (e.g., a UE) to initiate UE-assisted visual positioning or UE-based visual positioning with camera calibration performed based on network device(s) with known locations and RF capabilities.

At 1404, the first network node may receive, from a network entity, an indication of a set of training points and at least one image for an area captured by at least one camera of at least one second network node, where the first network node is in a FOV of the at least one camera of the at least one second network node, where the indication includes, for each of the set of training points, a pixel location in the at least one image and a world location, such as described in connection with FIG. 10. For example, at 1036, the CpRFDev 1004 may receive, from the server 1006, a set of training points (obtained from the matching as described in connection with FIG. 7) and also a set of image(s) for an area (or the extracted relevant pixels). The at least one image is taken by the CamDev 1002 and the CpRFDev 1004 is in the FOV of the CamDev. The reception of the set of training points and the at least one image may be performed by, e.g., the visual positioning component 198, the camera 1532, the application processor 1506, the cellular baseband processor 1524, and/or the transceiver(s) 1522 of the apparatus 1504 in FIG. 15.

In one example, the first network node may transmit, for the network entity, a request to estimate locations of one or more objects in the area using visual-based positioning, where the indication of the set of training points and the at least one image may be received from the network entity based on the request, such as described in connection with FIG. 10. For example, at 1020, a CpRFDev 1004 that is configured to perform or participate in a UE-based visual positioning session (e.g., for determining/estimating the location of one or more objects in a region) may transmit a location estimate request to a server 1006. The transmission of the request may be performed by, e.g., the visual positioning component 198, the camera 1532, the application processor 1506, the cellular baseband processor 1524, and/or the transceiver(s) 1522 of the apparatus 1504 in FIG. 15.

In another example, the first network node may extract, from the at least one image, a pixel location of the first network node; match a world location of the first network node to the pixel location of the first network node; and perform data normalization for the set of training points or the at least one image based on the world location of the first network node and the pixel location of the first network node, such as described in connection with FIG. 10. For example, at 1038, based on the training points and the image(s) taken (or the extracted relevant pixels) from the server 1006, the CpRFDev 1004 may perform data preparation and processing for the image(s) and/or the extracted relevant pixels, such as described in connection with the first functional block 812 of FIG. 8. For example, data preparation and processing may include: (1) determining relevant CamDev(s) and/or CpRFDev(s) for the visual positioning, (2) allocating resources specified for the information exchange between different nodes (e.g., between CamDev(s), CpRFDev(s) and the server), (3) pixel location extraction (e.g., extracting the pixel location of the CpRFDev 1004, such as using an object detection mechanism, (4) data normalization (e.g., standardization, whitening, etc.), or (5) a combination thereof. The extraction of the pixel location of the first network node, the matching of the world location of the first network node to the pixel location of the first network node, and/or the data normalization for the set of training points or the at least one image may be performed by, e.g., the visual positioning component 198, the camera 1532, the application processor 1506, the cellular baseband processor 1524, and/or the transceiver(s) 1522 of the apparatus 1504 in FIG. 15. In some implementations, the pixel location of the first network node is extracted using object detection.

At 1408, the first network node may estimate a projective transformation between a world location of an object and a pixel location of the object in the at least one image, based on the set of training points and a known location or an estimated location of the first network node, such as described in connection with FIG. 10. For example, at 1040, the CpRFDev 1004 may perform camera calibration based on the data preparation and processing, such as described in connection with the second functional block 814 of FIG. 8. For example, camera calibration may include outlier rejection (e.g., performing training point selection, such as using RANSAC), and/or projective transformation (calibration matrix) estimation as described in connection with FIGS. 5 to 7. The projective transformation may be performed by, e.g., the visual positioning component 198, the camera 1532, the application processor 1506, the cellular baseband processor 1524, and/or the transceiver(s) 1522 of the apparatus 1504 in FIG. 15. In some implementations, to estimate the projective transformation, the first network node may select a subset of training points from the set of training points, and generate a camera calibration matrix based on the subset of training points. In some implementations, the subset of training points may be selected from the set of training points based on a random sample consensus (RANSAC).

In one example, the first network node may estimate the locations of the one or more objects in the area based on the at least one image and the projective transformation, such as described in connection with FIG. 10. For example, at 1042, after performing the camera calibration, the CpRFDev 1004 may perform the visual positioning (e.g., the UE-based visual positioning) for one or more objects in the image(s) taken (or in the extracted relevant pixels), such as described in connection with the third functional block 816 of FIG. 8. The estimation of the locations of the one or more objects in the area may be performed by, e.g., the visual positioning component 198, the camera 1532, the application processor 1506, the cellular baseband processor 1524, and/or the transceiver(s) 1522 of the apparatus 1504 in FIG. 15. In some implementations, to estimate the locations of the one or more objects in the area based on the at least one image and the projective transformation, the first network node may compute image pixel locations of the one or more objects based on the at least one image. In some implementations, the one or more objects in the area are in the FOV of the at least one camera of the at least one second network node.

In another example, the first network node may be a base station or a TRP including the known location.

In another example, the first network node may be a UE including the estimated location. In some implementations, the first network node may obtain the estimated location of the first network node based on network-based positioning or GNSS-based positioning.

In another example, the one or more objects may be non-radio frequency (non-RF) objects or the one or more objects do not include RF capabilities.

In another example, the visual-based positioning is UE-based visual positioning.

In another example, the first network node may transmit, for the network entity, an indication of the estimated locations of the one or more objects in the area, such as described in connection with FIG. 10. For example, at 1044, the CpRFDev 1004 may transmit the result of the visual positioning to the server 1006 (if specified), such as the location estimates of one or more objects detected within the FOV of the CamDev 1002 (e.g., estimated locations of CpRFDev(s), NonCpRFDev(s), NonRFobj(s), etc.). The transmission of the indication of the estimated locations of the one or more objects in the area may be performed by, e.g., the visual positioning component 198, the camera 1532, the application processor 1506, the cellular baseband processor 1524, and/or the transceiver(s) 1522 of the apparatus 1504 in FIG. 15.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), an ultra-wideband (UWB) module 1536, one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, the UWB module 1536, and the SPS module 1516 may include an on-chip transceiver (TRX) (or in some cases, just a receiver (RX)). The Bluetooth module 1512, the WLAN module 1514, the UWB module 1536, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see UE 350 of FIG. 3) and include the additional modules of the apparatus 1504.

As discussed supra, the visual positioning component 198 may be configured to receive, from a network entity, an indication of a set of training points and at least one image for an area captured by at least one camera of at least one second network node, where the first network node is in a FOV of the at least one camera of the at least one second network node, where the indication includes, for each of the set of training points, a pixel location in the at least one image and a world location. The visual positioning component 198 may also be configured to estimate a projective transformation between a world location of an object and a pixel location of the object in the at least one image, based on the set of training points and a known location or an estimated location of the first network node. The visual positioning component 198 may be within the cellular baseband processor 1524, the application processor 1506, or both the cellular baseband processor 1524 and the application processor 1506. The visual positioning component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, may include means for receiving, from a network entity, an indication of a set of training points and at least one image for an area captured by at least one camera of at least one second network node, where the first network node is in a FOV of the at least one camera of the at least one second network node, where the indication includes, for each of the set of training points, a pixel location in the at least one image and a world location. The apparatus 1504 may further include means for estimating a projective transformation between a world location of an object and a pixel location of the object in the at least one image, based on the set of training points and a known location or an estimated location of the first network node.

In one configuration, the apparatus 1504 may further include means for extracting, from the at least one image, a pixel location of the apparatus 1504; means for matching a world location of the apparatus 1504 to the pixel location of the apparatus 1504; and means for performing data normalization for the set of training points or the at least one image based on the world location of the apparatus 1504 and the pixel location of the apparatus 1504. In some implementations, the pixel location of the apparatus 1504 is extracted using object detection.

In another configuration, the means for estimating the projective transformation may include configuring the apparatus 1504 to select a subset of training points from the set of training points, and generate a camera calibration matrix based on the subset of training points. In some implementations, the subset of training points may be selected from the set of training points based on a RANSAC.

In another configuration, the apparatus 1504 may further include means for transmitting, for the network entity, a request to estimate locations of one or more objects in the area using visual-based positioning, where the indication of the set of training points and the at least one image are received from the network entity based on the request, and means for estimating the locations of the one or more objects in the area based on the at least one image and the projective transformation. In some implementations, the means for estimating the locations of the one or more objects in the area based on the at least one image and the projective transformation may include configuring the apparatus 1504 to image pixel locations of the one or more objects based on the at least one image. In some implementations, the one or more objects in the area are in the FOV of the at least one camera of the at least one second network node.

In another configuration, the apparatus 1504 may be a base station or a TRP including the known location.

In another configuration, the apparatus 1504 may be a UE including the estimated location. In some implementations, the apparatus 1504 may further include means for obtaining the estimated location of the apparatus 1504 based on network-based positioning or GNSS-based positioning.

In another configuration, the one or more objects may be non-radio frequency (non-RF) objects or the one or more objects do not include RF capabilities.

In another configuration, the visual-based positioning is UE-based visual positioning.

In another configuration, the apparatus 1504 may further include means for transmitting, for the network entity, an indication of the estimated locations of the one or more objects in the area.

The means may be the visual positioning component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

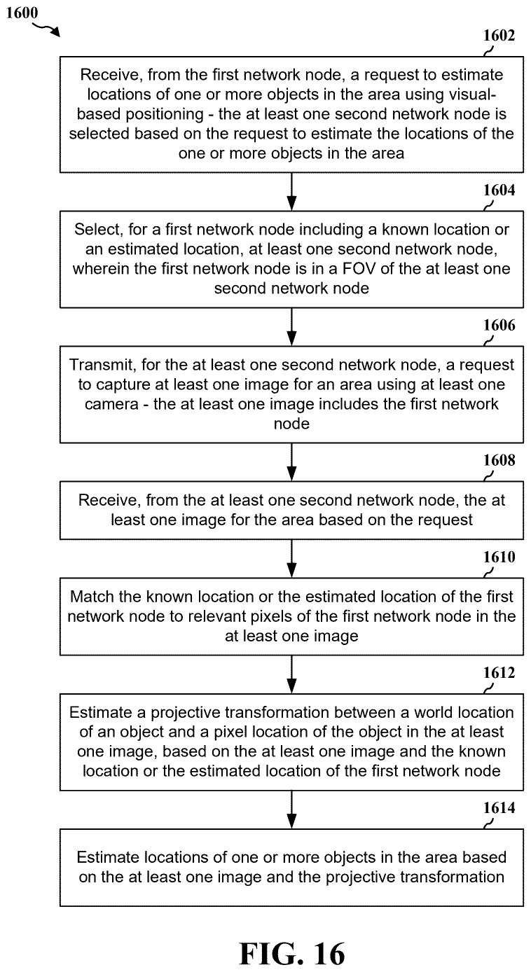

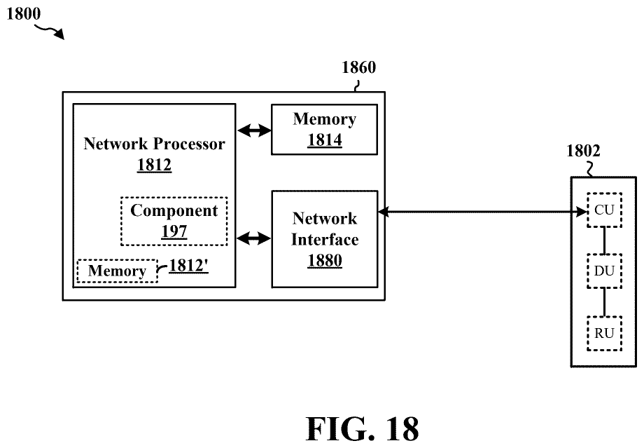

FIG. 16 is a flowchart 1600 of a method of wireless communication. The method may be performed by a network entity (e.g., the one or more location servers 168; the server 906, 1006, 1106, 1206; network entity 1860 (discussed in connection with FIG. 18 below)). The method may enable the network entity to coordinate multiple network devices (e.g., CpRFDev(s), Non CpRFDev(s), and/or CamDev(s)) for visual positioning with camera calibration performed based on network device(s) with known locations and RF capabilities.

At 1604, the network entity may select, for a first network node including a known location or an estimated location, at least one second network node, where the first network node is in a FOV of the at least one second network node, such as described in connection with FIG. 9. For example, at 926, the server 906 may determine a relevant CamDev 902 for participating in the UE-assisted visual positioning session. For example, the server 906 may select a CamDev in which the CpRFDev 904 (and also the one or more objects and/or the region to be detected) are in the FOV of the CamDev 902. The selection of the at least one second network node may be performed by, e.g., the visual positioning coordination component 197, the network processor 1812, and/or the network interface 1880 of the network entity 1860 in FIG. 18.

In one example, as shown at 1602, the network entity may receive, from the first network node, a request to estimate locations of one or more objects in the area using visual-based positioning, where the at least one second network node is selected based on the request to estimate the locations of the one or more objects in the area, such as described in connection with FIG. 9. For example, at 920, a server 906 may receive a location estimate request from a CpRFDev 904 that is configured to perform or participate in a UE-assisted visual positioning session (e.g., for determining/estimating the location of one or more objects in a region). The reception of the request to estimate locations of one or more objects may be performed by, e.g., the visual positioning coordination component 197, the network processor 1812, and/or the network interface 1880 of the network entity 1860 in FIG. 18.

In another example, to select the at least one second network node, the network entity may receive, from the first network node, a request to estimate locations of one or more objects in the area using visual-based positioning, where the at least one second network node is selected based on the request to estimate the locations of the one or more objects in the area; transmit, for a database, a query for a list of second network nodes around the first network node; receive, from the database, the list of second network nodes around the first network node.

At 1606, the network entity may transmit, for the at least one second network node, a request to capture at least one image for an area using at least one camera, where the at least one image includes the first network node, such as described in connection with FIG. 9. For example, at 928, after the server 906 determines the CamDev 902 to be participated in the UE-assisted visual positioning, the server 906 may transmit an image request to the CamDev 902 to request the CamDev 902 to take image(s) (e.g., capture the FOV of the CamDev 902). The transmission of the request to capture at least one image for the area may be performed by, e.g., the visual positioning coordination component 197, the network processor 1812, and/or the network interface 1880 of the network entity 1860 in FIG. 18.

At 1608, the network entity may receive, from the at least one second network node, the at least one image for the area based on the request, such as described in connection with FIG. 9. For example, at 932, the server 906 may receive, from the CamDev 902, the image(s) taken and/or the extracted relevant pixels (if performed by the CamDev 902). The reception of the at least one image for the area may be performed by, e.g., the visual positioning coordination component 197, the network processor 1812, and/or the network interface 1880 of the network entity 1860 in FIG. 18. In some implementations, the network entity may extract a set of relevant pixels of one or more objects from the at least one image.

In one example, the network entity may extract a set of training points from the at least one image; and transmit, for the first network node, an indication of the set of training points and the at least one image, where the indication includes, for each of the set of training points, a pixel location in the at least one image and a world location.

At 1610, the network entity may match the known location or the estimated location of the first network node to relevant pixels of the first network node in the at least one image, such as described in connection with FIG. 9. For example, at 934, based on the image(s) and/or the extracted relevant pixels from the CamDev 902, the server 906 may perform data preparation and processing for the image(s) and/or the extracted relevant pixels, such as described in connection with the first functional block 812 of FIG. 8. For example, data preparation and processing may include: (1) visual positioning procedure initiation, (2) determining relevant CamDev(s) and/or CpRFDev(s) for the visual positioning, (3) allocating resources specified for the information exchange between different nodes (e.g., between CamDev(s), CpRFDev(s) and the server), (4) pixel location extraction (e.g., extracting the pixel location of the CpRFDev 904, such as using an object detection mechanism, (5) matching (e.g., matching the world locations (e.g., WCS/2D/3D coordinates) of the CpRFDev 904 in the FOV of the CamDev 902 and their corresponding image pixel locations, (6) data normalization (e.g., standardization, whitening, etc.), or (7) a combination thereof. The matching of the known location or the estimated location of the first network node to relevant pixels of the first network node in the at least one image may be performed by, e.g., the visual positioning coordination component 197, the network processor 1812, and/or the network interface 1880 of the network entity 1860 in FIG. 18.

In one example, the network entity may extract, from the at least one image, a pixel location of the first network node; match a world location of the first network node to the pixel location of the first network node; and perform data normalization for the at least one image based on the world location of the first network node and the pixel location of the first network node.

At 1612, the network entity may estimate a projective transformation between a world location of an object and a pixel location of the object in the at least one image, based on the at least one image and the known location or the estimated location of the first network node, such as described in connection with FIG. 9. For example, at 936, the server 906 may perform camera calibration (e.g., projective transformation) based on the data preparation and processing, such as described in connection with the second functional block 814 of FIG. 8. For example, camera calibration may include outlier rejection (e.g., performing training point selection, such as using RANSAC), and/or projective transformation (calibration matrix) estimation as described in connection with FIGS. 5 to 7. The projective transformation may be performed by, e.g., the visual positioning coordination component 197, the network processor 1812, and/or the network interface 1880 of the network entity 1860 in FIG. 18.

At 1614, the network entity may estimate locations of one or more objects in the area based on the at least one image and the projective transformation, such as described in connection with FIG. 9. For example, at 938, after performing the camera calibration, the server 906 may perform the visual positioning (e.g., the UE-assisted visual positioning) for one or more objects in the image(s) taken (or in the extracted relevant pixels), such as described in connection with the third functional block 816 of FIG. 8. The estimation of the locations of the one or more objects in the area may be performed by, e.g., the visual positioning coordination component 197, the network processor 1812, and/or the network interface 1880 of the network entity 1860 in FIG. 18.

In one example, to estimate the locations of the one or more objects in the area based on the at least one image and the projective transformation, the network entity may compute image pixel locations of the one or more objects based on the at least one image.

In another example, the network entity may transmit, for the first network node, an indication of the estimated locations of the one or more objects in the area.

In another example, the first network node is a base station or a TRP including the known location.

In another example, the first network node is a UE including the estimated location. The network entity may obtain the estimated location of the first network node.

In another example, the one or more objects are non-radio frequency objects or the one or more objects do not include RF capabilities.

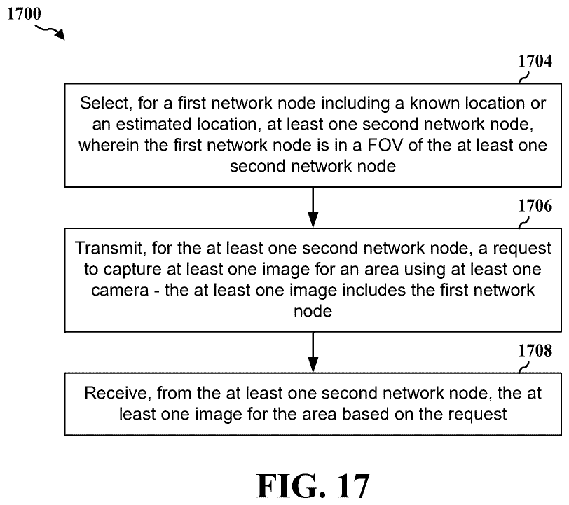

FIG. 17 is a flowchart 1700 of a method of wireless communication. The method may be performed by a network entity (e.g., the one or more location servers 168; the server 906, 1006, 1106, 1206; network entity 1860 (discussed in connection with FIG. 18 below)). The method may enable the network entity to coordinate multiple network devices (e.g., CpRFDev(s), Non CpRFDev(s), and/or CamDev(s)) for visual positioning with camera calibration performed based on network device(s) with known locations and RF capabilities.

At 1704, the network entity may select, for a first network node including a known location or an estimated location, at least one second network node, where the first network node is in a FOV of the at least one second network node, such as described in connection with FIG. 9. For example, at 926, the server 906 may determine a relevant CamDev 902 for participating in the UE-assisted visual positioning session. For example, the server 906 may select a CamDev in which the CpRFDev 904 (and also the one or more objects and/or the region to be detected) are in the FOV of the CamDev 902. The selection of the at least one second network node may be performed by, e.g., the visual positioning coordination component 197, the network processor 1812, and/or the network interface 1880 of the network entity 1860 in FIG. 18.

In one example, the network entity may receive, from the first network node, a request to estimate locations of one or more objects in the area using visual-based positioning, where the at least one second network node is selected based on the request to estimate the locations of the one or more objects in the area, such as described in connection with FIG. 9. For example, at 920, a server 906 may receive a location estimate request from a CpRFDev 904 that is configured to perform or participate in a UE-assisted visual positioning session (e.g., for determining/estimating the location of one or more objects in a region). The reception of the request to estimate locations of one or more objects may be performed by, e.g., the visual positioning coordination component 197, the network processor 1812, and/or the network interface 1880 of the network entity 1860 in FIG. 18.

In another example, to select the at least one second network node, the network entity may receive, from the first network node, a request to estimate locations of one or more objects in the area using visual-based positioning, where the at least one second network node is selected based on the request to estimate the locations of the one or more objects in the area; transmit, for a database, a query for a list of second network nodes around the first network node; receive, from the database, the list of second network nodes around the first network node.

At 1606, the network entity may transmit, for the at least one second network node, a request to capture at least one image for an area using at least one camera, where the at least one image includes the first network node, such as described in connection with FIG. 9. For example, at 928, after the server 906 determines the CamDev 902 to be participated in the UE-assisted visual positioning, the server 906 may transmit an image request to the CamDev 902 to request the CamDev 902 to take image(s) (e.g., capture the FOV of the CamDev 902). The transmission of the request to capture at least one image for the area may be performed by, e.g., the visual positioning coordination component 197, the network processor 1812, and/or the network interface 1880 of the network entity 1860 in FIG. 18.

At 1608, the network entity may receive, from the at least one second network node, the at least one image for the area based on the request, such as described in connection with FIG. 9. For example, at 932, the server 906 may receive, from the CamDev 902, the image(s) taken and/or the extracted relevant pixels (if performed by the CamDev 902). The reception of the at least one image for the area may be performed by, e.g., the visual positioning coordination component 197, the network processor 1812, and/or the network interface 1880 of the network entity 1860 in FIG. 18. In some implementations, the network entity may extract a set of relevant pixels of one or more objects from the at least one image.

In one example, the network entity may extract a set of training points from the at least one image; and transmit, for the first network node, an indication of the set of training points and the at least one image, where the indication includes, for each of the set of training points, a pixel location in the at least one image and a world location.

In another example, the network entity may match the known location or the estimated location of the first network node to relevant pixels of the first network node in the at least one image, such as described in connection with FIG. 9. For example, at 934, based on the image(s) and/or the extracted relevant pixels from the CamDev 902, the server 906 may perform data preparation and processing for the image(s) and/or the extracted relevant pixels, such as described in connection with the first functional block 812 of FIG. 8. For example, data preparation and processing may include: (1) visual positioning procedure initiation, (2) determining relevant CamDev(s) and/or CpRFDev(s) for the visual positioning, (3) allocating resources specified for the information exchange between different nodes (e.g., between CamDev(s), CpRFDev(s) and the server), (4) pixel location extraction (e.g., extracting the pixel location of the CpRFDev 904, such as using an object detection mechanism, (5) matching (e.g., matching the world locations (e.g., WCS/2D/3D coordinates) of the CpRFDev 904 in the FOV of the CamDev 902 and their corresponding image pixel locations, (6) data normalization (e.g., standardization, whitening, etc.), or (7) a combination thereof. The matching of the known location or the estimated location of the first network node to relevant pixels of the first network node in the at least one image may be performed by, e.g., the visual positioning coordination component 197, the network processor 1812, and/or the network interface 1880 of the network entity 1860 in FIG. 18.

In another example, the network entity may extract, from the at least one image, a pixel location of the first network node; match a world location of the first network node to the pixel location of the first network node; and perform data normalization for the at least one image based on the world location of the first network node and the pixel location of the first network node.

In another example, the network entity may estimate a projective transformation between a world location of an object and a pixel location of the object in the at least one image, based on the at least one image and the known location or the estimated location of the first network node, such as described in connection with FIG. 9. For example, at 936, the server 906 may perform camera calibration (e.g., projective transformation) based on the data preparation and processing, such as described in connection with the second functional block 814 of FIG. 8. For example, camera calibration may include outlier rejection (e.g., performing training point selection, such as using RANSAC), and/or projective transformation (calibration matrix) estimation as described in connection with FIGS. 5 to 7. The projective transformation may be performed by, e.g., the visual positioning coordination component 197, the network processor 1812, and/or the network interface 1880 of the network entity 1860 in FIG. 18.

In another example, the network entity may estimate locations of one or more objects in the area based on the at least one image and the projective transformation, such as described in connection with FIG. 9. For example, at 938, after performing the camera calibration, the server 906 may perform the visual positioning (e.g., the UE-assisted visual positioning) for one or more objects in the image(s) taken (or in the extracted relevant pixels), such as described in connection with the third functional block 816 of FIG. 8. The estimation of the locations of the one or more objects in the area may be performed by, e.g., the visual positioning coordination component 197, the network processor 1812, and/or the network interface 1880 of the network entity 1860 in FIG. 18.

In another example, to estimate the locations of the one or more objects in the area based on the at least one image and the projective transformation, the network entity may compute image pixel locations of the one or more objects based on the at least one image.

In another example, the network entity may transmit, for the first network node, an indication of the estimated locations of the one or more objects in the area.

In another example, the first network node is a base station or a TRP including the known location.

In another example, the first network node is a UE including the estimated location. The network entity may obtain the estimated location of the first network node.

In another example, the one or more objects are non-radio frequency objects or the one or more objects do not include RF capabilities.

FIG. 18 is a diagram 1800 illustrating an example of a hardware implementation for a network entity 1860. In one example, the network entity 1860 may be within the core network 120. The network entity 1860 may include a network processor 1812. The network processor 1812 may include on-chip memory 1812′. In some aspects, the network entity 1860 may further include additional memory modules 1814. The network entity 1860 communicates via the network interface 1880 directly (e.g., backhaul link) or indirectly (e.g., through a RIC) with the CU 1802. The on-chip memory 1812′ and the additional memory modules 1814 may each be considered a computer-readable medium/memory. Each computer-readable medium/memory may be non-transitory. The processor 1812 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the visual positioning coordination component 197 may be configured to select, for a first network node including a known location or an estimated location, at least one second network node, where the first network node is in a FOV of the at least one second network node. The visual positioning coordination component 197 may also be configured to transmit, for the at least one second network node, a request to capture at least one image for an area using at least one camera, where the at least one image includes the first network node. The visual positioning coordination component 197 may also be configured to receive, from the at least one second network node, the at least one image for the area based on the request. The visual positioning coordination component 197 may be within the processor 1812. The visual positioning coordination component 197 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1860 may include a variety of components configured for various functions. In one configuration, the network entity 1860 may include means for selecting, for a first network node including a known location or an estimated location, at least one second network node, where the first network node is in a FOV of the at least one second network node. The network entity 1860 may further include means for transmitting, for the at least one second network node, a request to capture at least one image for an area using at least one camera, where the at least one image includes the first network node. The network entity 1860 may further include means for receiving, from the at least one second network node, the at least one image for the area based on the request.

In one configuration, the means for selecting the at least one second network node may include configuring the network entity 1860 to receive, from the first network node, a request to estimate locations of one or more objects in the area using visual-based positioning, where the at least one second network node is selected based on the request to estimate the locations of the one or more objects in the area; transmit, for a database, a query for a list of second network nodes around the first network node; receive, from the database, the list of second network nodes around the first network node; and determine the at least one second network node from the list of second network nodes.

In another configuration, the network entity 1860 may further include means for extracting a set of relevant pixels of one or more objects from the at least one image.

In another configuration, the network entity 1860 may further include means for extracting a set of training points from the at least one image, and means for transmitting, for the first network node, the set of training points and the at least one image.

In another configuration, the network entity 1860 may further include means for matching the known location or the estimated location of the first network node to relevant pixels of the first network node in the at least one image.

In another configuration, the network entity 1860 may further include means for extracting a set of training points from the at least one image; and means for transmitting, for the first network node, an indication of the set of training points and the at least one image, where the indication includes, for each of the set of training points, a pixel location in the at least one image and a world location.

In another configuration, the network entity 1860 may further include means for estimating a projective transformation between a world location of an object and a pixel location of the object in the at least one image, based on the at least one image and the known location or the estimated location of the first network node.

In another configuration, the network entity 1860 may further include means for estimating locations of one or more objects in the area based on the at least one image and the projective transformation.

In another configuration, the means for estimating the locations of the one or more objects in the area based on the at least one image and the projective transformation may include configuring the network entity 1860 to compute image pixel locations of the one or more objects based on the at least one image.

In another configuration, the network entity 1860 may further include means for transmitting, for the first network node, an indication of the estimated locations of the one or more objects in the area.

In another configuration, the first network node is a base station or a TRP including the known location.

In another configuration, the first network node is a UE including the estimated location. The network entity 1860 may further include means for obtaining the estimated location of the first network node.

In another configuration, the one or more objects are non-radio frequency objects or the one or more objects do not include RF capabilities.

The means may be the visual positioning coordination component 197 of the network entity 1860 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network node, including: receiving, from a network entity, an indication of a set of training points and at least one image for an area captured by at least one camera of at least one second network node, where the first network node is in a field-of-view (FOV) of the at least one camera of the at least one second network node, where the indication includes, for each of the set of training points, a pixel location in the at least one image and a world location; and estimating a projective transformation between a world location of an object and a pixel location of the object in the at least one image, based on the set of training points and a known location or an estimated location of the first network node.

Aspect 2 is the method of aspect 1, further including: transmitting, for the network entity, a request to estimate locations of one or more objects in the area using visual-based positioning, where the indication of the set of training points and the at least one image are received from the network entity based on the request; and estimating the locations of the one or more objects in the area based on the at least one image and the projective transformation.

Aspect 3 is the method of aspect 2, where estimating the locations of the one or more objects in the area based on the at least one image and the projective transformation includes: computing image pixel locations of the one or more objects based on the at least one image.

Aspect 4 is the method of any of aspects 2 to 3, further including: transmitting, for the network entity, an indication of the estimated locations of the one or more objects in the area.

Aspect 5 is the method of any of aspects 2 to 4, where the one or more objects in the area are in the FOV of the at least one camera of the at least one second network node.

Aspect 6 is the method of any of aspects 1 to 5, further including: extracting, from the at least one image, a pixel location of the first network node; matching a world location of the first network node to the pixel location of the first network node; and performing data normalization for the set of training points or the at least one image based on the world location of the first network node and the pixel location of the first network node.

Aspect 7 is the method of aspect 6, where the pixel location of the first network node is extracted using object detection.

Aspect 8 is the method of any of aspects 1 to 7, where estimating the projective transformation includes: selecting a subset of training points from the set of training points; and generating a camera calibration matrix based on the subset of training points.

Aspect 9 is the method of aspect 8, where the subset of training points is selected from the set of training points based on a RANSAC.

Aspect 10 is the method of any of aspects 1 to 9, where the first network node is a base station or a TRP including the known location.

Aspect 11 is the method of any of aspects 1 to 10, where the first network node is a UE including the estimated location, and further including: obtaining the estimated location of the first network node based on network-based positioning or GNSS-based positioning.

Aspect 12 is the method of any of aspects 1 to 11, where the one or more objects are non-radio frequency (non-RF) objects or the one or more objects do not include RF capabilities.

Aspect 13 is the method of any of aspects 1 to 12, where the visual-based positioning is UE-based visual positioning.

Aspect 14 is an apparatus for wireless communication at a first network node, including: a memory; and at least one processor coupled to the memory and, based at least in part on information stored in the memory, the at least one processor is configured to implement any of aspects 1 to 13.

Aspect 15 is the apparatus of aspect 14, further including at least one of a transceiver or an antenna coupled to the at least one processor.

Aspect 16 is an apparatus for wireless communication including means for implementing any of aspects 1 to 13.

Aspect 17 is a computer-readable medium (e.g., a non-transitory computer-readable medium) storing computer executable code, where the code when executed by a processor causes the processor to implement any of aspects 1 to 13.

Aspect 18 is a method of wireless communication at a network entity, including: selecting, for a first network node including a known location or an estimated location, at least one second network node, where the first network node is in a field-of-view (FOV) of the at least one second network node; transmit, for the at least one second network node, a request to capture at least one image for an area using at least one camera, where the at least one image includes the first network node; and receive, from the at least one second network node, the at least one image for the area based on the request.

Aspect 19 is the method of aspect 18, where selecting the at least one second network node includes: receiving, from the first network node, a request to estimate locations of one or more objects in the area using visual-based positioning, where the at least one second network node is selected based on the request to estimate the locations of the one or more objects in the area; transmitting, for a database, a query for a list of second network nodes around the first network node; receiving, from the database, the list of second network nodes around the first network node; and determining the at least one second network node from the list of second network nodes.

Aspect 20 is the method of aspect 18 or 19, further including: extracting a set of relevant pixels of one or more objects from the at least one image.

Aspect 21 is the method of any of aspects 18 to 20, further including: matching the known location or the estimated location of the first network node to relevant pixels of the first network node in the at least one image.

Aspect 22 is the method of any of aspects 18 to 21, further including: extracting a set of training points from the at least one image; and transmitting, for the first network node, an indication of the set of training points and the at least one image, where the indication includes, for each of the set of training points, a pixel location in the at least one image and a world location.

Aspect 23 is the method of any of aspects 18 to 22, further including: estimating a projective transformation between a world location of an object and a pixel location of the object in the at least one image, based on the at least one image and the known location or the estimated location of the first network node.

Aspect 24 is the method of aspect 23, further including: estimating locations of one or more objects in the area based on the at least one image and the projective transformation.

Aspect 25 is the method of aspect 24, where estimating the locations of the one or more objects in the area based on the at least one image and the projective transformation includes: computing image pixel locations of the one or more objects based on the at least one image.

Aspect 26 is the method of any of aspects 24 to 25, further including: transmitting, for the first network node, an indication of the estimated locations of the one or more objects in the area.

Aspect 27 is the method of any of aspects 18 to 26, further including: extracting, from the at least one image, a pixel location of the first network node; matching a world location of the first network node to the pixel location of the first network node; and performing data normalization for the at least one image based on the world location of the first network node and the pixel location of the first network node.

Aspect 28 is the method of any of aspects 18 to 27, where the first network node is a base station or a TRP including the known location.

Aspect 29 is the method of any of aspects 18 to 28, where the first network node is a UE including the estimated location, and further including: obtaining the estimated location of the first network node.

Aspect 30 is the method of any of aspects 18 to 29, where the one or more objects are non-radio frequency (non-RF) objects or the one or more objects do not include RF capabilities

Aspect 31 is an apparatus for wireless communication at a network entity, including: a memory; and at least one processor coupled to the memory and, based at least in part on information stored in the memory, the at least one processor is configured to implement any of aspects 18 to 30.

Aspect 32 is the apparatus of aspect 31, further including at least one of a transceiver or an antenna coupled to the at least one processor.

Aspect 33 is an apparatus for wireless communication including means for implementing any of aspects 18 to 30.

Aspect 34 is a computer-readable medium (e.g., a non-transitory computer-readable medium) storing computer executable code, where the code when executed by a processor causes the processor to implement any of aspects 18 to 30.

1. An apparatus for wireless communication at a first network node, comprising:
a memory; and
at least one processor coupled to the memory, and the at least one processor is configured to:
transmit, for a network entity, a request to estimate locations of one or more objects in a defined area using visual-based positioning;
receive, from the network entity, a set of training points and a set of images for the defined area captured by at least one camera of at least one second network node, wherein the first network node is in a field-of-view (FOV) of the at least one camera of the at least one second network node, wherein the set of training points is extracted from the set of images; and
perform a camera calibration for the at least one camera of the at least one second network node based on the set of training points and a known location or an estimated location of the first network node.

2. The apparatus of claim 1, wherein the at least one processor is further configured to:
estimate the locations of the one or more objects in the defined area based on the set of images and the camera calibration.

3. The apparatus of claim 2, wherein to estimate the locations of the one or more objects in the defined area based on the set of images and the camera calibration, the at least one processor is configured to:
compute image pixel locations of the one or more objects based on the set of images.

4. The apparatus of claim 2, wherein the at least one processor is further configured to:
transmit, for the network entity, an indication of the estimated locations of the one or more objects in the defined area.

5. The apparatus of claim 2, wherein the one or more objects in the defined area are in the FOV of the at least one camera of the at least one second network node.

6. The apparatus of claim 1, wherein the at least one processor is further configured to:
extract, from the set of images, a pixel location of the first network node;
match a world location of the first network node to the pixel location of the first network node; and
perform data normalization for the set of training points or the set of images based on the world location of the first network node and the pixel location of the first network node.

7. The apparatus of claim 6, wherein the at least one processor is configured to extract the pixel location of the first network node using object detection.

8. The apparatus of claim 1, wherein to perform the camera calibration for the at least one camera of the at least one second network node, the at least one processor is configured to:
select a subset of training points from the set of training points; and
generate a camera calibration matrix based on the subset of training points.

9. (canceled)

10. (canceled)

11. The apparatus of claim 1, wherein the first network node is a user equipment (UE) including the estimated location, and wherein the at least one processor is further configured to:
obtain the estimated location of the first network node based on network-based positioning or Global Navigation Satellite Systems (GNSS)-based positioning.

12. (canceled)

13. (canceled)

14. The apparatus of claim 1, further comprising a transceiver coupled to the at least one processor, wherein to transmit the request to estimate the locations of the one or more objects in the defined area, the at least one processor is configured to transmit, via the transceiver, the request to estimate the locations of the one or more objects in the defined area using the visual-based positioning, and wherein to receive the set of training points and the set of images for the defined area, the at least one processor is configured to receive, via the transceiver, the set of training points and the set of images for the defined area captured by the at least one camera of the at least one second network node.

15. (canceled)

16. An apparatus for wireless communication at a network entity, comprising:
a memory; and
at least one processor coupled to the memory, and the at least one processor is configured to:
receive, from a first network node including a known location or an estimated location, a first request to estimate locations of one or more objects in a defined area using visual-based positioning;
select at least one second network node based on the first request, wherein the first network node is in a field-of-view (FOV) of the at least one second network node;
transmit, for the at least one second network node, a second request to capture a set of images for the defined area using at least one camera, wherein the set of images includes the first network node; and
receive, from the at least one second network node, the set of images for the defined area based on the second request.

17. The apparatus of claim 16, wherein to select the at least one second network node based on the first request, the at least one processor is configured to:
transmit, for a database, a query for a list of second network nodes around the first network node;
receive, from the database, the list of second network nodes around the first network node; and
determine the at least one second network node from the list of second network nodes.

18. (canceled)

19. The apparatus of claim 16 wherein the at least one processor is further configured to:
match the known location or the estimated location of the first network node to relevant pixels of the first network node in the set of images.

20. The apparatus of claim 16 wherein the at least one processor is further configured to:
extract a set of training points from the set of images; and
transmit, for the first network node, the set of training points and the set of images.

21. (canceled)

22. The apparatus of claim 21, wherein the at least one processor is further configured to:
estimate the locations of the one or more objects in the defined area based on the set of images and the camera calibration.

23. The apparatus of claim 22, wherein to estimate the locations of the one or more objects in the defined area based on the set of images and the camera calibration, the at least one processor is configured to:
compute image pixel locations of the one or more objects based on the set of images.

24. The apparatus of claim 22, wherein the at least one processor is further configured to:
transmit, for the first network node, an indication of the estimated locations of the one or more objects in the defined area.

25. The apparatus of claim 16, wherein the at least one processor is further configured to:
extract, from the set of images, a pixel location of the first network node;
match a world location of the first network node to the pixel location of the first network node; and
perform data normalization for the set of images based on the world location of the first network node and the pixel location of the first network node.

26. (canceled)

27. (canceled)

28. (canceled)

29. The apparatus of claim 16, further comprising a transceiver coupled to the at least one processor, wherein to receive the first request to estimate the locations of the one or more objects in the defined area, the at least one processor is configured to receive, via the transceiver, the first request to estimate the locations of the one or more objects in the defined area using the visual-based positioning, wherein to transmit the second request to capture the set of images for the defined area, the at least one processor is configured to transmit, via the transceiver, the second request to capture the set of images for the defined area using the at least one camera, and wherein to receive the set of images for the defined area, the at least one processor is configured to receive, via the transceiver, the set of images for the defined area based on the second request.

30. A method of wireless communication at a network entity, comprising:
receiving, from a first network node including a known location or an estimated location, a first request to estimate locations of one or more objects in a defined area using visual-based positioning;
selecting at least one second network node based on the first request, wherein the first network node is in a field-of-view (FOV) of the at least one second network node;
transmitting, for the at least one second network node, a second request to capture a set of images for the defined area using at least one camera, wherein the set of images includes the first network node; and
receiving, from the at least one second network node, the set of images for the defined area based on the second request.
